(19) United States
(12) Patent Application Publication
(10) Pub. No.: US 2012/0306855 A1
(43) Pub. Date: Dec. 6, 2012

(54) STORAGE MEDIUM HAVING STORED THEREIN DISPLAY CONTROL PROGRAM, DISPLAY CONTROL APPARATUS, DISPLAY CONTROL METHOD, AND DISPLAY CONTROL SYSTEM

(75) Inventors: Naohiko AOYAMA, Kyoto-shi (JP); Junya Kadono, Kyoto-shi (JP); Yuusuke Ozawa, Kyoto-shi (JP); Kaoru Kita, Kyoto-shi (JP)

(73) Assignee: NINTENDO CO., LTD., Kyoto (JP)

(21) Appl. No.: 13/234,545

(22) Filed: Sep. 16, 2011

(30) Foreign Application Priority Data
Jun. 3, 2011 (JP) 2011-125578

(51) Int. Cl. G06T 15/00

(52) U.S. Cl. 345/419

(57) ABSTRACT

A computer of an example display control apparatus configured to perform a stereoscopic display and a planar-view display on a display unit, the computer being caused to function as: stereoscopic display control means; display switching means; and planar visible object display control means. The stereoscopic display control means performs a stereoscopic display of a virtual space on the display unit. The display switching means switches the stereoscopic display of the virtual space on the display unit performed by the stereoscopic display control means to a planar-view display thereof, in accordance with predetermined switching conditions. The planar visible object display control means displays a planar visible object on the display unit after the stereoscopic display is switched by the display switching means to the planar-view display.

### CROSS REFERENCE TO RELATED APPLICATION

The disclosure of Japanese Patent Application No. 2011-125578, filed on Jun. 3, 2011, is incorporated herein by reference.

### BACKGROUND AND SUMMARY

The example embodiments described herein relate to a storage medium having stored therein a display control program, a display control apparatus, a display control method, and a display control system, and more particularly, relates to a storage medium having stored therein a display control program which performs a stereoscopic display, a display control apparatus, a display control method, and a display control system.

Conventionally, a method in which two images (a right-eye image and a left-eye image) having disparity therebetween are used to perform a stereoscopic display has been known. According to the method, a stereoscopic display can be performed by arranging two virtual cameras in a virtual three-dimensional space, and rendering an image which includes a subject, such as a virtual object, based on each virtual camera. Also, a method for expanding stereoscopic effects by widening an interval between two virtual cameras, or a method for switching to a planar-view display (non-stereoscopic display) by setting the interval between the two virtual cameras to be 0 have been known.

The above methods, however, merely set the interval between the two virtual cameras, in accordance with a depth value at a view position, and are not for displaying an object, which is viewed in a planar manner, (particularly, an object the shape of which is modeled into a planar shape) in a stereoscopically displayed virtual three-dimensional space.

Therefore, a main feature of the example embodiments is to provide a novel storage medium having stored therein a display control program, a novel display control apparatus, a novel display control method, and a novel display control system. In addition, another feature of the example embodiments is to provide a storage medium having stored therein a display control program which allows reduction in sense of discomfort of the appearance of an object, which is viewed in a planar manner, when displaying the object in a stereoscopically displayed virtual space, a display control apparatus, a display control method, and a display control system.

In order to achieve the objects, the example embodiments employ the following features.

The example embodiments are a computer-readable storage medium having stored therein a display control program to be executed by a computer of a display control apparatus configured to perform a stereoscopic display and a planar-view display on a display unit. The display control program causes the computer to function as: stereoscopic display control means; display switching means; and planar visible object display control means. The stereoscopic display control means performs a stereoscopic display of a virtual space on the display unit. The display switching means switches the stereoscopic display of the virtual space on the display unit performed by the stereoscopic display control means to a planar-view display thereof, in accordance with predetermined switching conditions. The planar visible object display control means displays a planar visible object on the display unit after the stereoscopic display is switched by the display switching means to the planar-view display.

According to the above configuration, when displaying the planar visible object (planarly displayed object) on the display unit, the display of the display unit is switched from the stereoscopic display to the planar-view display. Therefore, the planar visible object is displayed on the display unit on which the planar-view display is performed. Thus, a sense of discomfort of the appearance caused by the planar visible object being displayed in the stereoscopic display can be reduced.

The display switching means may switch from the planar-view display to the stereoscopic display after the planar visible object is displayed by the planar visible object display control means.

According to the above configuration, the planar-view display is switched to the stereoscopic display after the planar visible object is displayed. This allows the planar visible object to be stereoscopically displayed while reducing the sense of discomfort of the appearance when displaying the planar visible object on the display unit on which the stereoscopic display is performed.

The computer may be caused to further function as object conversion means for converting the planar visible object into a solid model object representing a solid model of the planar visible object. In this case, the planar visible object display control means displays a planar model object representing a planar model of the planar visible object, as the planar visible object, on the display unit. The object conversion means converts the planar model object into the solid model object and places the solid model object in the virtual space. The display switching means switches from the planar-view display of the virtual space, in which the solid model object into which the planar model object is converted by the object conversion means is placed, to the stereoscopic display thereof.

According to the above configuration, when the planar-view display is switched to the stereoscopic display after the planar model object is displayed, the planar model object is converted into the solid model object. That is, when the planar-view display is switched to the stereoscopic display, the planar visible object displayed on the display unit is also converted from the planar model into the solid model and is placed in the virtual space. This allows the virtual space, in which the solid model object is placed, to be switched to the stereoscopic display in a comfortable manner.

The display unit includes: a first display section configured to perform a planar-view display and a stereoscopic display; and a second display section configured to perform a planar-view display, and the planar visible object may be an object planarly displayed on the second display section.

According to the above configuration, the planarly displayed object is displayed on a display section different from a display section on which the stereoscopic display is performed, and therefore the stereoscopically displayed virtual space and the planarly displayed object can be viewed at the same time and independent of each other.

The stereoscopic display of the virtual space by the stereoscopic display control means, display switching by the display switching means, and the display of the planar visible object by the planar visible object display control means may be performed as follows. That is, the stereoscopic display control means performs the stereoscopic display of the virtual space on the first display section. the display switching means switches the stereoscopic display of the virtual space on the first display section performed by the stereoscopic display control means to the planar-view display thereof, in accordance with the predetermined switching conditions. After the stereoscopic display of the virtual space on the first display section is switched by the display switching means to the planar-view display thereof, the planar visible object display control means deletes the planar visible object planarly displayed on the second display section from the second display section, and displays the planar visible object on the first display section.

According to the above configuration, the planar visible object displayed on the second display section is deleted from the second display section, and the deleted planar visible object is displayed on the first display section displaying the virtual space. This allows a realization of presentation as if the planar visible object outside the virtual space moves into the virtual space.

The computer may be caused to further function as capture image output control means. The capture image output control means acquires, as a capture image, a planar visible image of the planar-view display of the virtual space switched by the display switching means, and, and outputs the capture image to the display unit. In this case, the planar visible object display control means displays the planar visible object on the capture image outputted to the display unit.

According to the above configuration, when displaying the planar visible object on the display unit on which the stereoscopic display is performed, the stereoscopic display of the virtual space is switched to the planar-view display thereof, and planarly displayed virtual space is outputted as the capture image (a single image having a planar shape) to the display unit. Thus, when displaying the planar visible object on the display unit, the user is allowed to view as if the planar visible object is placed (displayed) on the capture image, which is the single planar-shaped image, and the sense of discomfort of the appearance when placing the planar visible object in the stereoscopically displayed virtual space can be reduced. In a case where the planar visible object is a planar-modeled object, the planar-modeled object is placed (displayed) on the capture image having the planar shape. Therefore, the sense of discomfort of the appearance can be further reduced. Because of this, the example embodiments are effective in the case where the planar visible object is a planar-modeled object.

The capture image output control means may output the capture image on a reference plane where no disparity occurs in the virtual space displayed on the display unit.

According to the above configuration, the capture image (a single planar-shaped image representing the planarly displayed virtual space) is placed on the reference plane where no disparity occurs in the virtual space. This causes no disparity change in the capture image even when the display of the virtual space is switched between the planar-view display and the stereoscopic display, and thus there is no change in appearance. This allows the reduction in sense of discomfort of the appearance even when switching the display of the virtual space placed in the capture image between the planar-view display and the stereoscopic display.

The computer may be caused to further function as capture image change means. The capture image change means changes the capture image outputted by the capture image output control means so as to tilt in a depth direction in the virtual space.

According to the above configuration, the capture image changes so as to tilt in the depth direction in the virtual space. This allows the user to view the capture image as a single planar-shaped image placed in the virtual space in an emphasizing manner. This gives the user an image, when an object is placed on the capture image in the virtual space, that the object is placed on the single planar-shaped image.

The computer may be caused to further function as virtual camera setting means, and the stereoscopic display of the virtual space by the stereoscopic display control means and the display switching by the display switching means may be performed as follows. That is, the virtual camera setting means arranges two virtual cameras, which take images of the virtual space, so as to have a predetermined interval therebetween. The stereoscopic display control means performs the stereoscopically display of the virtual space on the display unit by outputting a stereoscopically visible image made up of a right-eye image and a left-eye image taken, of the virtual space, by the two virtual cameras arranged by the virtual camera setting means so as to have the predetermined interval therebetween. By causing the virtual camera setting means to set 0 to the predetermined interval between the two virtual cameras, the display switching means switches the stereoscopic display of the virtual space performed by the stereoscopic display control means to the planar-view display thereof.

According to the above configuration, the switching from the stereoscopic display of the virtual space to the planar-view display thereof is realized by setting 0 to the predetermined interval (a distance between the virtual cameras) under which the two virtual cameras are arranged. This allows the switching from the stereoscopic display of the virtual space to the planar-view display thereof to be realized by controlling the distance between the virtual cameras.

The display switching means may switch the stereoscopic display of the virtual space performed by the stereoscopic display control means to the planar-view display thereof by causing the virtual camera setting means to set the predetermined interval between the two virtual cameras to be gradually reduced.

According to the above configuration, the switching from the stereoscopic display of the virtual space to the planar-view display thereof is realized by the predetermined interval (the distance between the virtual cameras) under which the two virtual cameras are arranged to be gradually reduced and become 0. This executes the switching from the stereoscopic display of the virtual space to the planar-view display thereof in a gradual manner, and the switching can be executed in a comfortable manner.

The computer may be caused to further function as display conditions determination means. The display conditions determination means determines whether display conditions for displaying the planar visible object on the display unit are satisfied. In this case, the predetermined switching conditions are that the display conditions determination means determines that the display conditions are satisfied.

According to the above configuration, a predetermined timing when the stereoscopic display of the virtual space is switched to the planar-view display thereof is when it is determined that the display conditions for displaying the planar visible object on the display unit are satisfied. This allows the switching from the stereoscopic display of the virtual space to the planar-view display thereof to be performed at a suitable timing for displaying the planar visible object, and thus allows the switching to be performed in a comfortable manner.

The computer may be caused to further function as input reception means for receiving an input from a user, and position locating means. The position locating means locates a position in the virtual space, based on the input received by the input reception means. In this case, the display conditions determination means makes determination, based on conditions, as the display conditions, that the position located by the position locating means is the predetermined position.

According to the above configuration, the display conditions for displaying the planar visible object on the display unit is that the position in the virtual space, located based on the input from the user, is the predetermined position. Because of this, if the position located based on the user's input is not the predetermined position, the display conditions for displaying the planar visible object on the display unit are not satisfied, and thus the stereoscopic display of the virtual space does not switch to the planar-view display thereof. Therefore, in the case where the user operation does not satisfy the conditions, the display of the virtual space does not switch to the planar-view display.

The computer may be caused to further function as input reception means for receiving an input from the user, and planar visible object identification means. The planar visible object identification means identifies, based on the input received by the input reception means, a planar visible object to be displayed on the first display section, among planar visible objects planarly displayed on the second display section. In this case, the planar visible object display control means displays on the first display section the planar visible object identified by the planar visible object identification means.

According to the above configuration, the planar visible object identified based on the input from the user is displayed on the first display section. Therefore, the user can select a desired planar visible object among objects planarly displayed on the second display section, and display the desired planar visible object on the first display section.

The computer may be caused to further function as virtual camera setting means, and the stereoscopic display of the virtual space by the stereoscopic display control means, and the display switching by the display switching means may be performed as follows. That is, the virtual camera setting means arranges two virtual cameras, which take images of the virtual space, so as to have a predetermined interval therebetween. The stereoscopic display control means performs the stereoscopic display of the virtual space on the display unit by outputting a stereoscopically visible image made up of a right-eye image and a left-eye image taken, of the virtual space, by the two virtual cameras arranged by the virtual camera setting means so as to have the predetermined interval therebetween. By replacing the stereoscopically visible image with a single planar visible image rendering the virtual space, the display switching means switches the stereoscopic display of the virtual space performed by the stereoscopic display control means to the planar-view display thereof.

According to the above configuration, the switching from the stereoscopic display of the virtual space to the planar-view display thereof is realized by replacing the stereoscopically visible image with a single planar visible image. This also allows easy switching from the stereoscopic display of the virtual space to the planar-view display thereof.

In the above description, the case where the example embodiments are implemented as a computer-readable storage medium having stored therein a display control program. The example embodiments, however, may be implemented as a display control apparatus, a display control method, or a display control system.

(Definition of Terminology)

As used herein, a term “stereoscopic display” refers to stereoscopically displaying a virtual space by allowing a user to view, with a right eye and a left eye, respectively, a right-eye image and a left-eye image (both images) taken, of the virtual space, by two virtual cameras. The both images taken by the virtual cameras are collectively referred to as “stereoscopically visible image”. On the other hand, “planar-view display” has an opposite meaning to the “stereoscopic display” described above, and refers to planarly displaying a virtual space, and allowing the user to view one image with the right and left eyes. Also, the one image is referred to as “planar visible image”.

According to the example embodiments, a computer-readable storage medium having stored therein a novel display control program or the like can be provided. A computer-readable storage medium or the like having stored therein a display control program, which allows reduction in sense of discomfort of the appearance of an object, which is viewed in the planar manner, when displaying the object in the stereoscopically displayed virtual space, can also be provided.

These and other objects, features, aspects and advantages of exemplary embodiments will become more apparent from the following detailed description of the exemplary embodiments when taken in conjunction with the accompanying drawings.

### BRIEF DESCRIPTION OF THE DRAWINGS

FIG. 1 is a front view of a game apparatus 10 in an opened state;

FIG. 2 shows a left side view, a front view, a right side view, a rear view of the game apparatus 10 in a closed state;

FIG. 3 is a block diagram illustrating, by way of example, an internal configuration of the game apparatus 10;

FIG. 4 is a diagram illustrating, by way of example, an overhead view of a virtual space images of which are taken (rendered) by virtual cameras;

FIG. 5 shows diagrams illustrating a disparity of a virtual object;

FIG. 6 is a diagram illustrating, by way of example, a stereoscopic view;

FIG. 7 shows diagrams illustrating, by way of example, a game executed by the game apparatus 10;

FIG. 8 is a diagram illustrating, by way of example, the game executed by the game apparatus 10;

FIG. 9 is a diagram illustrating, by way of example, the game executed by the game apparatus 10;

FIG. 10 is a diagram illustrating, by way of example, the game executed by the game apparatus 10;

FIG. 11 is a diagram illustrating, by way of example, the game executed by the game apparatus 10;

FIG. 12 shows diagrams illustrating, by way of example, the game executed by the game apparatus 10;

FIG. 13 is a diagram illustrating, by way of example, the game executed by the game apparatus 10;

FIG. 14 is a diagram illustrating, by way of example, the game executed by the game apparatus 10;

FIG. 15 is a diagram illustrating, by way of example, the game executed by the game apparatus 10;

FIG. 16 is a diagram showing, by way of example, a memory map of a main memory 32 in the game apparatus 10;

FIG. 17 is a flowchart illustrating, by way of example, a display control process; and

FIG. 18 is a flowchart illustrating, by way of example, a display switching process.

### DETAILED DESCRIPTION OF NON-LIMITING EXAMPLE EMBODIMENTS

### One Embodiment

Hereinafter, a game apparatus which is a display control apparatus according to one example embodiment will be described. The example embodiment is not limited to such apparatus, and may be a display control system which realizes functionality of such apparatus, a display control method in such apparatus, and a computer-readable storage medium having stored therein a display control program executed in such apparatus.

(External Structure of Game Apparatus)

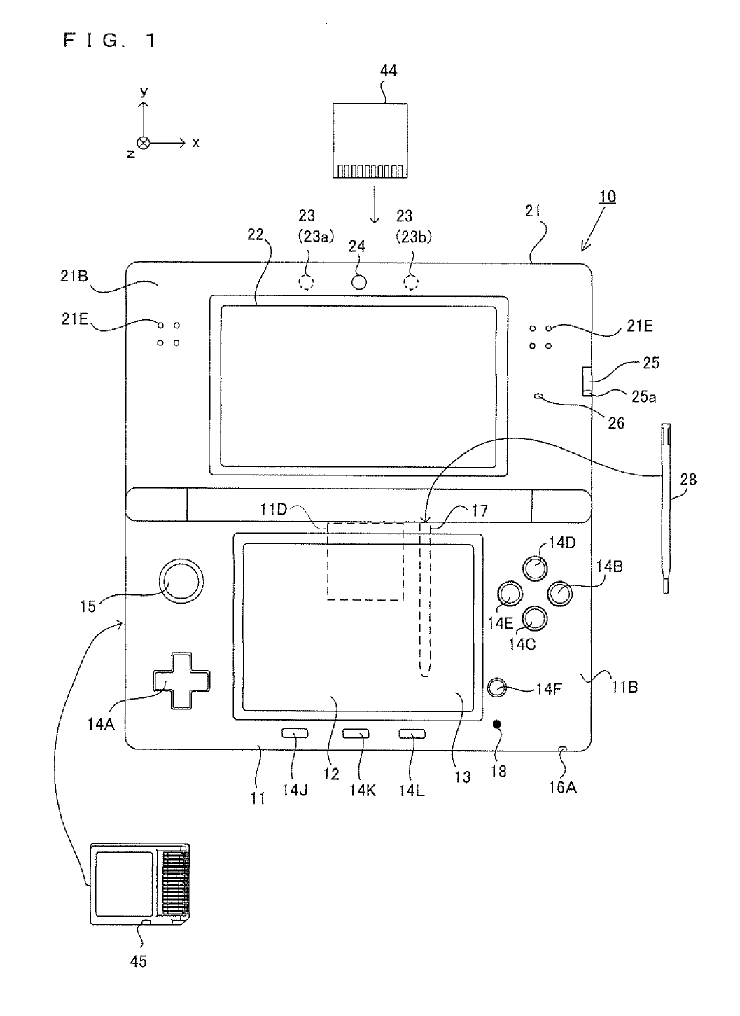

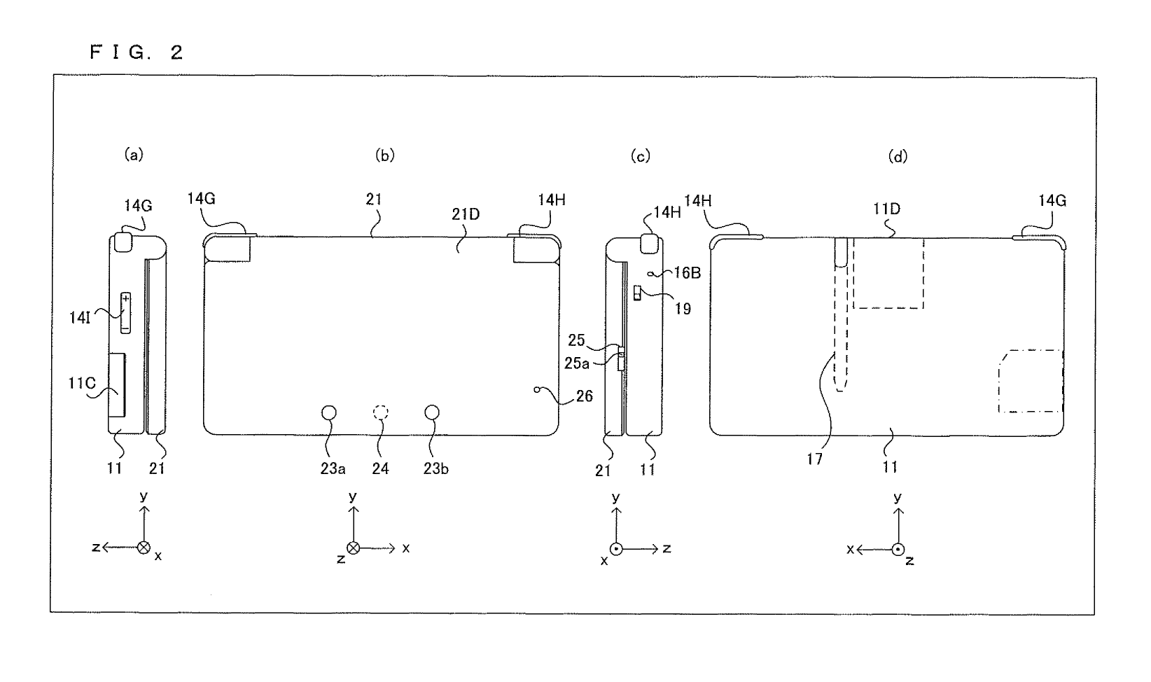

Hereinafter, a game apparatus according to one example embodiment will be described. FIG. 1 and FIG. 2 show plan views of an outer appearance of a game apparatus 10. The game apparatus 10 is a hand-held game apparatus, and is configured to be foldable as shown in FIG. 1 and FIG. 2. FIG. 1 shows the game apparatus 10 in an opened state, and FIG. 2 shows the game apparatus 10 in a closed state. FIG. 1 is a front view of the game apparatus 10 in the opened state. The game apparatus 10 is able to take an image by an imaging section, display the taken image on a screen, and store data of the taken image. The game apparatus 10 can execute a game program which is stored in an exchangeable memory card or a game program which is received from a server or another game apparatus, and can display, on the screen, an image generated by computer graphics processing, such as an image taken by a virtual camera set in a virtual space, for example.

Initially, an external structure of the game apparatus 10 will be described with reference to FIG. 1 and FIG. 2. The game apparatus 10 includes a lower housing 11 and an upper housing 21 as shown in FIG. 1 and FIG. 2. The lower housing 11 and the upper housing 21 are connected to each other so as to be openable and closable (foldable).

(Description of Lower Housing)

Initially, a structure of the lower housing 11 will be described. As shown in FIG. 1 and FIG. 2, in the lower housing 11, a lower LCD (Liquid Crystal Display) 12, a touch panel 13, operation buttons 14A to 14L, an analog stick 15, an LED 16A and an LED 16B, an insertion opening 17, and a microphone hole 18 are provided. Hereinafter, these components will be described in detail.

As shown in FIG. 1, the lower LCD 12 is accommodated in the lower housing 11. The number of pixels of the lower LCD 12 may be, for example, 320 dots×240 dots (the horizontal line×the vertical line). The lower LCD 12 is a display device for displaying an image in a planar manner (not in a stereoscopically visible manner), which is different from the upper LCD 22 described below. Although an LCD is used as a display device in the present embodiment, any other display device such as a display device using an EL (Electro Luminescence), or the like may be used. In addition, a display device having any resolution may be used as the lower LCD 12.

As shown in FIG. 1, the game apparatus 10 includes the touch panel 13 as an input device. The touch panel 13 is mounted on the screen of the lower LCD 12. In the present embodiment, the touch panel 13 is, but is not limited to, a resistive film type touch panel. A touch panel of any type such as electrostatic capacitance type may be used. In the present embodiment, the touch panel 13 has the same resolution (detection accuracy) as that of the lower LCD 12. However, the resolution of the touch panel 13 and the resolution of the lower LCD 12 may not necessarily be the same. Further, the insertion opening 17 (indicated by dashed line in FIG. 1 and (d) of FIG. 2) is provided on the upper side surface of the lower housing 11. The insertion opening 17 is used for accommodating a touch pen 28 which is used for performing an operation on the touch panel 13. Although an input on the touch panel 13 is usually made by using the touch pen 28, a user's finger may be used for making an input on the touch panel 13, in addition to the touch pen 28.

The operation buttons 14A to 14L are each an input device for making a predetermined input. As shown in FIG. 1, among the operation buttons 14A to 14L, a cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11. The cross button 14A is cross-shaped, and includes buttons for indicating an upward, a downward, a leftward, or a rightward direction. The buttons 14A to 14E, the selection button 14J, the HOME button 14K, and the start button 14L are assigned respective functions accordingly, in accordance with a program executed by the game apparatus 10.

The analog stick 15 is a device for indicating a direction. The analog stick 15 has a top, corresponding to a key, which slides parallel to the inner side surface of the lower housing 11. The analog stick 15 acts in accordance with a program executed by the game apparatus 10. As the analog stick 15, a component which enables an analog input by being tilted by a predetermined amount, in any direction, such as the upward, the downward, the rightward, the leftward, or the diagonal direction, may be used.

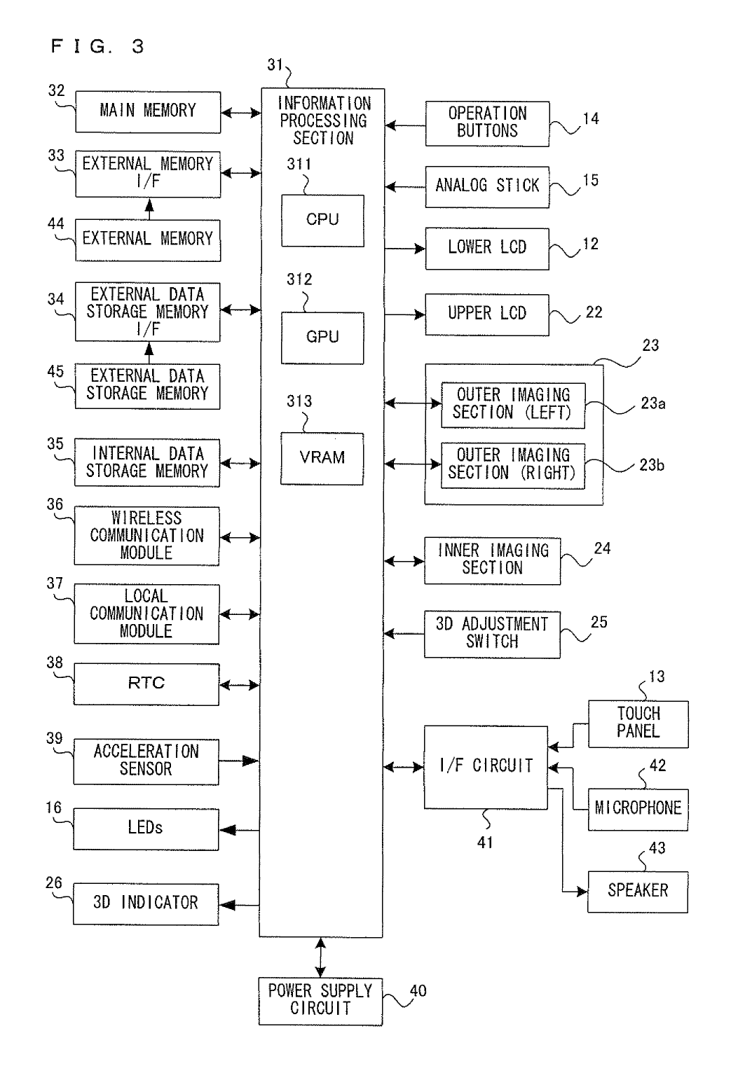

Further, the microphone hole 18 is provided on the inner side surface of the lower housing 11. Under the microphone hole 18, a microphone 42 (see FIG. 3) is provided as a sound input device described below, and the microphone 42 detects for a sound from the outside of the game apparatus 10.

Part (a) of FIG. 2 is a left side view of the game apparatus 10 in the closed state. Part (b) of FIG. 2 is a front view of the game apparatus 10 in the closed state. Part (c) of FIG. 2 is a right side view of the game apparatus 10 in the closed state. Part (d) of FIG. 2 is a rear view of the game apparatus 10 in the closed state. As shown in (b) and (d) of FIG. 2, an L button 14G and an R button 14H are provided on the upper side surface of the lower housing 11. L button 14G and an R button 14H can act, for example, as shutter buttons (imaging instruction buttons) of the imaging section. Further, as shown in (a) of FIG. 2, a sound volume button 14I is provided on the left side surface of the lower housing 11. The sound volume button 14I is used for adjusting a sound volume of a speaker of the game apparatus 10.

As shown in (a) of FIG. 2, a cover section 11C is provided on the left side surface of the lower housing 11 so as to be openable and closable. Inside the cover section 11C, a connector (not shown) is provided for electrically connecting between the game apparatus 10 and an external data storage memory 45. The external data storage memory 45 is detachably connected to the connector. The external data storage memory 45 is used for, for example, recording (storing) data of an image taken by the game apparatus 10.

Further, as shown in (d) of FIG. 2, an insertion opening 11D through which an external memory 44 having a game program stored therein is inserted is provided on the upper side surface of the lower housing 11. A connector (not shown) for electrically connecting between the game apparatus 10 and the external memory 44 in a detachable manner is provided inside the insertion opening 11D. A predetermined game program is executed by connecting the external memory 44 to the game apparatus 10.

Further, as shown in FIG. 1 and (c) of FIG. 2, a first LED 16A for notifying a user of an ON/OFF state of a power supply of the game apparatus 10 is provided on the lower side surface of the lower housing 11, and a second LED 16B for notifying a user of an establishment state of a wireless communication of the game apparatus 10 is provided on the right side surface of the lower housing 11. The game apparatus 10 can perform a wireless communication with other devices, and the second LED 16B is lit up when the wireless communication is established. The game apparatus 10 has a function of connecting to a wireless LAN in a method based on, for example, IEEE 802.11b/g standard. A wireless switch 19 for enabling/disabling the function of the wireless communication is provided on the right side surface of the lower housing 11 (see (c) of FIG. 2).

A rechargeable battery (not shown) acting as a power supply for the game apparatus 10 is accommodated in the lower housing 11, and the battery can be charged through a terminal provided on a side surface (for example, the upper side surface) of the lower housing 11.

(Description of Upper Housing)

Next, a structure of the upper housing 21 will be described. As shown in FIG. 1 and FIG. 2, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided.

Hereinafter, theses components will be described in detail.

As shown in FIG. 1, the upper LCD 22 is accommodated in the upper housing 21. The number of pixels of the upper LCD 22 may be, for example, 800 dots×240 dots (the horizontal line×the vertical line). Although, in the present embodiment, the upper LCD 22 is an LCD, a display device using an EL (Electro Luminescence) or the like may be used. In addition, a display device having any resolution may be used as the upper LCD 22.

The upper LCD 22 is a display device capable of displaying a stereoscopically visible image (the stereoscopic image). Further, in the present embodiment, a left-eye image and a right-eye image are displayed using substantially the same display area. Specifically, the upper LCD 22 is a display device using a method in which the left-eye image and the right-eye image are alternately displayed in the horizontal direction in predetermined units (for example, every other line). Alternatively, a display device using a method, in which the left-eye image and the right-eye image are alternately displayed by a time division scheme, may be used. Further, in the present embodiment, the upper LCD 22 is a display device capable of displaying an image which is stereoscopically visible with the naked eye. A lenticular lens type display device or a parallax barrier type display device is used which enables the left-eye image and the right-eye image, which are alternately displayed in the horizontal direction, to be separately viewed by the left eye and the right eye, respectively. In the present embodiment, the upper LCD 22 of a parallax barrier type is used. The upper LCD 22 displays, by using the left-eye image and the right-eye image, an image (a stereoscopic image) which is stereoscopically viewable with the naked eye. Specifically, the upper LCD 22 allows a user to view the left-eye image with her/his left eye, and the right-eye image with her/his right eye by utilizing a parallax barrier, so that a stereoscopic image (a stereoscopically visible image) exerting a stereoscopic effect for a user can be displayed. Further, the upper LCD 22 may disable the parallax barrier. When the parallax barrier is disabled, an image can be displayed in a planar manner (it is possible to display a planar visible image which is different from a stereoscopically visible image as described above. Specifically, a display mode is used in which the displayed same image is viewed with a left eye and a right eye). Thus, the upper LCD 22 is a display device capable of switching between a stereoscopic display mode for displaying a stereoscopically visible image and a planar-view display mode for planarly displaying an image (performing the planar-view display). The switching of the display mode is performed by the 3D adjustment switch 25 described below.

Two imaging sections (23a and 23b) provided on the outer side surface (the back surface reverse of the main surface on which the upper LCD 22 is provided) 21D of the upper housing 21 are generically referred to as the outer imaging section 23. In the present embodiment, the outer imaging section 23 includes two imaging sections: an outer imaging section (left) 23a; and an outer imaging section (right) 23b. The imaging directions of the outer imaging section (left) 23a and the outer imaging section (right) 23b are the same as the outward normal direction of the outer side surface 21D (a z-axis positive direction shown in FIG. 1). That is, the imaging direction of the outer imaging section (left) 23a and the imaging direction of the outer imaging section (right) 23b are parallel to each other. The outer imaging section (left) 23a and the outer imaging section (right) 23b can be used as a stereo camera, depending on a program executed by the game apparatus 10. Further, depending on a program, the outer imaging section 23 may be used as a non-stereo camera by using any one of the two outer imaging sections (23a and 23b) alone. Further, depending on a program, images taken by the two outer imaging sections (23a and 23b) may be combined with each other or may compensate for each other, thereby enabling imaging using an expanded imaging range. Each of the outer imaging section (left) 23a and the outer imaging section (right) 23b includes an imaging device, such as a CCD image sensor or a CMOS image sensor, having a common predetermined resolution, and a lens. The lens may have a zooming mechanism.

As indicated by dashed lines in FIG. 1 and by solid lines in (h) of FIG. 2, the outer imaging section (left) 23a and the outer imaging section (right) 23b forming the outer imaging section 23 are aligned so as to be parallel to the horizontal direction of the screen of the upper LCD 22 (an x-axis direction shown in FIG. 1). Specifically, the outer imaging section (left) 23a and the outer imaging section (right) 23b are positioned such that a straight line connecting between the two imaging sections is parallel to the horizontal direction of the screen of the upper LCD 22. Reference numerals 23a and 23b which are indicated as dashed lines in FIG. 1 represent the outer imaging section (left) 23a and the outer imaging section (right) 23b, respectively, which are positioned on the outer side surface reverse of the inner side surface of the upper housing 21. As shown in FIG. 1, when a user views the screen of the upper LCD 22 from the front thereof, the outer imaging section (left) 23a is positioned on the left of the upper LCD 22 and the outer imaging section (right) 23b is positioned on the right of the upper LCD 22. When a program for causing the outer imaging section 23 to function as a stereo camera is executed, the outer imaging section (left) 23a takes a left-eye image, which is viewed with the user's left eye, and the outer imaging section (right) 23b takes a right-eye image, which is viewed by the user's right eye. An interval between the outer imaging section (left) 23a and the outer imaging section (right) 23b is set so as to be approximately the same as an interval between both eyes of a person, that is, may be set so as to be within a range from 30 mm to 70 mm, for example. However, the interval between the outer imaging section (left) 23a and the outer imaging section (right) 23b is not limited to an interval within the range described above.

In the present embodiment, the outer imaging section (left) 23a and the outer imaging section (right) 23b are secured to the housing, and the imaging directions thereof cannot be changed.

Further, the outer imaging section (left) 23a and the outer imaging section (right) 23b are positioned on the left and to the right, respectively, of the upper LCD 22 (the upper housing 21) so as to be horizontally symmetrical with respect to the center of the upper LCD 22 (the x-axis direction shown in FIG. 1). Specifically, the outer imaging section (left) 23a and the outer imaging section (right) 23b are placed at horizontally symmetrical positions about a line which divides the upper LCD 22 into two equal parts, that is, the left part and the right part. Further, the outer imaging section (left) 23a and the outer imaging section (right) 23b are placed at positions which are reverse of positions above the upper edge of the screen of the upper LCD 22 and which are on the upper portion of the upper housing 21 in an opened state. Specifically, when the upper LCD 22 is projected on the outer side surface of the upper housing 21, the outer imaging section (left) 23a and the outer imaging section (right) 23b are placed, on the outer side surface of the upper housing 21, at a position above the upper edge of the screen of the upper LCD 22 having been projected.

As described above, the two imaging sections (23a and 23b) of the outer imaging section 23 are placed at horizontally symmetrical positions about the center of the upper LCD 22. Therefore, when a user views the upper LCD 22 from the front thereof, the imaging direction of the outer imaging section 23 can be the same as the viewing direction of the user. Further, the outer imaging section 23 is placed at a position reverse of a position above the upper edge of the screen of the upper LCD 22. Therefore, the outer imaging section 23 and the upper LCD 22 do not interfere with each other inside the upper housing 21. Therefore, the upper housing 21 may have a reduced thickness as compared to a case where the outer imaging section 23 is placed on a position reverse of a position of the screen of the upper LCD 22.

The inner imaging section 24 is an imaging section provided on the inner side surface (main surface) 21B of the upper housing 21, and has an imaging direction which is the same direction as the inward normal direction of the inner side surface (the z-axis negative direction shown in FIG. 1). The inner imaging section 24 includes an imaging device, such as a CCD image sensor and a CMOS image sensor, having a predetermined resolution, and a lens. The lens may have a zooming mechanism.

The 3D adjustment switch 25 is a slide switch, and is used for switching the display mode of the upper LCD 22 as described above. Further, the 3D adjustment switch 25 is used for adjusting the stereoscopic effect of a stereoscopically visible image (stereoscopic image) displayed on the upper LCD 22. A slider 25a of the 3D adjustment switch 25 is slidable to any position in a predetermined direction (along the longitudinal direction of the right side surface), and a display mode of the upper LCD 22 is set in accordance with the position of the slider 25a. Further, the appearance of the stereoscopically visible image is adjusted in accordance with the position of the slider 25a the slider 25a.

The 3D indicator 26 indicates whether or not the upper LCD 22 is in the stereoscopic display mode. The 3D indicator 26 is implemented as an LED, and is lit up when the stereoscopic display mode of the upper LCD 22 is enabled. The 3D indicator 26 may be lit up only when the program processing for displaying a stereoscopically visible image is performed in a state where the upper LCD 22 is in the stereoscopic display mode.

Further, a speaker hole 21E is provided on the inner side surface of the upper housing 21. A sound from a speaker 43 described below is outputted through the speaker hole 21E.

(Internal Configuration of Game Apparatus 10)

Next, an internal electrical configuration of the game apparatus 10 will be described with reference to FIG. 3. FIG. 3 is a block diagram illustrating an internal configuration of the game apparatus 10. As shown in FIG. 3, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, a power supply circuit 40, an interface circuit (I/F circuit) 41, and the like. These electronic components are mounted on an electronic circuit substrate, and accommodated in the lower housing 11 (or the upper housing 21).

The information processing section 31 is information processing means which includes a CPU (Central Processing Unit) 311 for executing a predetermined program, a GPU (Graphics Processing Unit) 312 for performing image processing, and the like. The CPU 311 of the information processing section 31 executes a program stored in a memory (for example, the external memory 44 connected to the external memory I/F 33 or the internal data storage memory 35) inside the game apparatus 10, thereby executing a process according to the program. The program executed by the CPU 311 of the information processing section 31 may be acquired from another device through communication with the other device. The information processing section 31 further includes a VRAM (Video RAM) 313. The GPU 312 of the information processing section 31 generates an image in accordance with an instruction from the CPU 311 of the information processing section 31, and renders the image in the VRAM 313. The GPU 312 of the information processing section 31 outputs the image rendered in the VRAM 313, to the upper LCD 22 and/or the lower LCD 12, and the image is displayed on the upper LCD 22 and/or the lower LCD 12.

To the information processing section 31, the main memory 32, the external memory I/F 33, the external data storage memory I/F 34, and the internal data storage memory 35 are connected. The external memory I/F 33 is an interface for detachably connecting to the external memory 44. The external data storage memory I/F 34 is an interface for detachably connecting to the external data storage memory 45.

The main memory 32 is volatile storage means used as a work area and a buffer area for (the CPU 311 of) the information processing section 31. That is, the main memory 32 temporarily stores various types of data used for the process based on the program, and temporarily stores a program acquired from the outside (the external memory 44, other device, or the like), for example. In the present embodiment, for example, a PSRAM (Pseudo-SRAM) is used as the main memory 32.

The external memory 44 is nonvolatile storage means for storing a program executed by the information processing section 31. The external memory 44 is implemented as, for example, a read-only semiconductor memory. When the external memory 44 is connected to the external memory I/F 33, the information processing section 31 can load a program stored in the external memory 44. A predetermined process is performed by the program loaded by the information processing section 31 being executed. The external data storage memory 45 is implemented as a non-volatile readable and writable memory (for example, a NAND flash memory), and is used for storing predetermined data. For example, images taken by the outer imaging section 23 and/or images taken by another device are stored in the external data storage memory 45. When the external data storage memory 45 is connected to the external data storage memory I/F 34, the information processing section 31 can load an image stored in the external data storage memory 45, and display the image on the upper LCD 22 and/or the lower LCD 12.

The internal data storage memory 35 is implemented as a non-volatile readable and writable memory (for example, a NAND flash memory), and is used for storing predetermined data or the predetermined program.

The wireless communication module 36 has a function of connecting to a wireless LAN by a method based on, for example, IEEE 802.11b/g standard. The local communication module 37 has a function of performing a wireless communication with the same type of game apparatus by a predetermined communication method (for example, communication through a unique protocol, or infrared communication). The wireless communication module 36 and the local communication module 37 are connected to the information processing section 31. The information processing section 31 can perform data transmission to and data reception from another device via the Internet by using the wireless communication module 36, and can perform data transmission to and data reception from the same type of another game apparatus by using the local communication module 37.

The acceleration sensor 39 is connected to the information processing section 31. The acceleration sensor 39 detects magnitudes of accelerations (linear accelerations) in the directions of the straight lines along the three axial (xyz axial) directions, respectively. The acceleration sensor 39 is provided inside the lower housing 11. In the acceleration sensor 39, as shown in FIG. 1, the long side direction of the lower housing 11 is defined as x axial direction, the short side direction of the lower housing 11 is defined as y axial direction, and the direction perpendicular to the inner side surface (main surface) of the lower housing 11 is defined as z axial direction, thereby detecting magnitudes of the linear accelerations for the respective axes. The acceleration sensor 39 is, for example, an electrostatic capacitance type acceleration sensor. However, another type of acceleration sensor may be used. The acceleration sensor 39 may be an acceleration sensor for detecting a magnitude of acceleration for one axial direction or two-axial directions. The information processing section 31 can receive data (acceleration data) representing accelerations detected by the acceleration sensor 39, and detect an orientation and a motion of the game apparatus 10. In addition to the acceleration sensor 39 (or instead of the acceleration sensor 39), other sensor, such as an angle sensor or an angular velocity sensor, may be connected to the information processing section 31, and an orientation or motion of the game apparatus 10 may be detected by the other sensor.

The RTC 38 and the power supply circuit 40 are connected to the information processing section 31. The RTC 38 counts time, and outputs the time to the information processing section 31. The information processing section 31 calculates a current time (date) based on the time counted by the RTC 38. The power supply circuit 40 controls power from the power supply (the above-described rechargeable battery accommodated in the lower housing 11) of the game apparatus 10, and supplies power to each component of the game apparatus 10.

Further, the LED 16 (16A and 16B) is connected to the information processing section 31. The information processing section 31 notifies a user of an ON/OFF state of a power supply of the game apparatus 10, and also notifies a user of an establishment state of wireless communication of the game apparatus 10, by using the LED 16.

The I/F circuit 41 is connected to the information processing section 31. The microphone 42 and the speaker 43 are connected to the I/F circuit 41. Specifically, the speaker 43 is connected to the I/F circuit 41 through an amplifier which is not shown. The microphone 42 detects a user's voice, and outputs a sound signal to the I/F circuit 41. The amplifier amplifies a sound signal outputted from the I/F circuit 41, and a sound is outputted from the speaker 43. The touch panel 13 is connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The touch position data represents coordinates of a position, on an input surface of the touch panel 13, on which an input is made. The touch panel control circuit reads a signal outputted from the touch panel 13 and generates the touch position data every predetermined time. The information processing section 31 acquires the touch position data, and thereby recognizes a position on which an input is made on the touch panel 13.

The operation buttons 14 includes the operation buttons 14A to 14L described above, and are connected to the information processing section 31. Operation data representing an input state of each of the operation buttons 14A to 14I is outputted from the corresponding operation buttons 14 to the information processing section 31, and the input state indicates whether or not each of the operation buttons 14A to 14I has been pressed. The information processing section 31 acquires the operation data from the operation button 14 to perform a process in accordance with the input on the operation button 14.

The analog stick 15 is connected to the information processing section 31. Operation data representing an analog input (operation direction and an amount of operation) on the analog stick 15 is output to the information processing section 31. The information processing section 31 acquires the operation data from the analog stick 15 to execute a process in accordance with the input on the analog stick 15.

The lower LCD 12 and the upper LCD 22 are connected to the information processing section 31. The lower LCD 12 and the upper LCD 22 each display an image in accordance with an instruction from (the GPU 312 of) the information processing section 31. In the present embodiment, the information processing section 31 displays a stereoscopic image (a stereoscopically visible image) on the upper LCD 22.

Specifically, the information processing section 31 is connected to an LCD controller (not shown) of the upper LCD 22, and causes the LCD controller to set the parallax barrier ON or OFF (enable/disable). When the parallax barrier in the upper LCD 22 is set ON, the right-eye image and the left-eye image, which are stored in the VRAM 313 of the information processing section 31, are outputted to the upper LCD 22. More specifically, the LCD controller alternately repeats reading of pixel data of the right-eye image for one line in the vertical direction, and reading of pixel data of the left-eye image for one line in the vertical direction, thereby reading the right-eye image and the left-eye image from the VRAM 313. Thus, an image to be displayed is divided into the images for the right eye and the images for the left eye each of which is a rectangle-shaped image having one line of pixels aligned in the vertical direction, and an image, in which the rectangle-shaped left-eye image which is obtained through the division, and the rectangle-shaped right-eye image which is obtained through the division are alternately aligned, is displayed on the screen of the upper LCD 22. A user views the images through the parallax barrier in the upper LCD 22 so that the right-eye image is viewed with the user's right eye, and the left-eye image is viewed with the user's left eye. Thus, the stereoscopically visible image is displayed on the screen of the upper LCD 22.

The outer imaging section 23 and the inner imaging section 24 are connected to the information processing section 31. The outer imaging section 23 and the inner imaging section 24 each take an image in accordance with an instruction from the information processing section 31 and output data of the taken image to the information processing section 31.

The 3D adjustment switch 25 is connected to the information processing section 31. The 3D adjustment switch 25 transmits, to the information processing section 31, an electrical signal in accordance with the position of the slider 25a.

The 3D indicator 26 is connected to the information processing section 31. The information processing section 31 controls whether or not the 3D indicator 26 is to be lit up. For example, the information processing section 31 lights up the 3D indicator 26 when the upper LCD 22 is in the stereoscopic display mode. This is the end of the description of the internal configuration of the game apparatus 10.

(Imaging Virtual Space by Virtual Cameras)

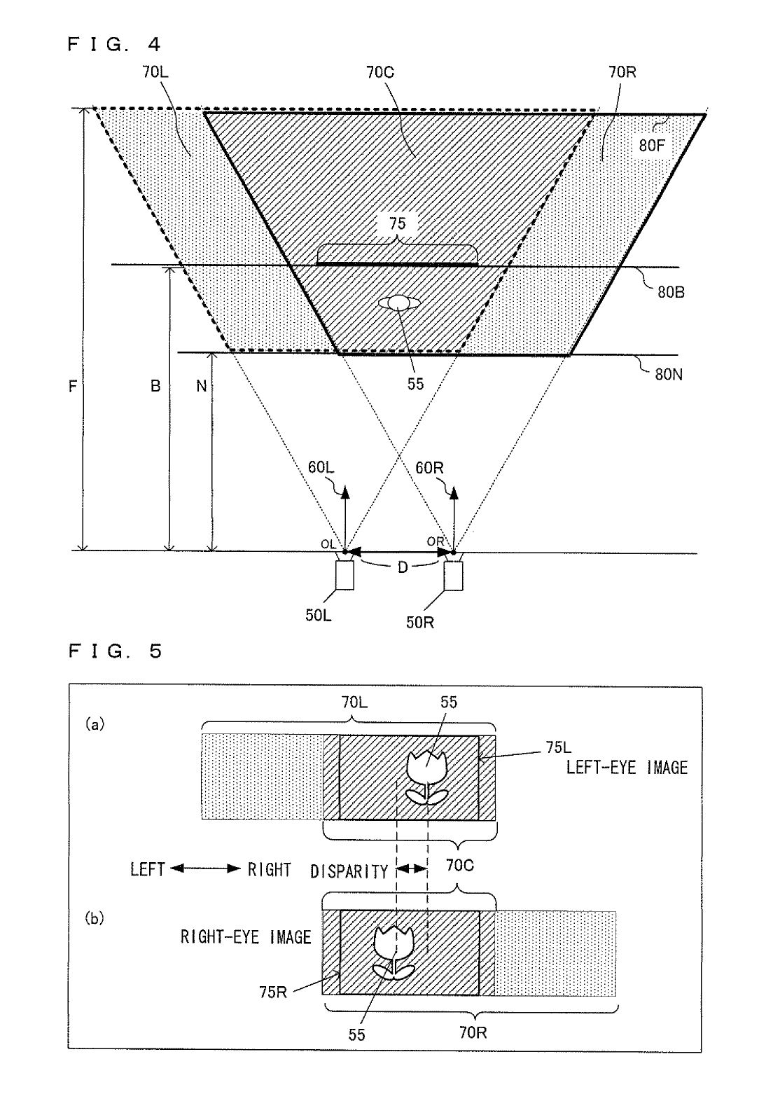

First, a generation method (rendering method) of a stereoscopically visible image (stereoscopic image) will be described with reference to FIG. 4 and FIG. 5. FIG. 4 is a diagram showing an overhead view of a virtual space, images of which are taken (rendered) by virtual cameras, to illustrate a positional relationship between the virtual cameras, and rendering ranges in the virtual space (virtual three-dimensional space). FIG. 5 is a diagram illustrating a disparity of a virtual object between a left-eye image rendered by a virtual left camera and a right-eye image rendered by a virtual right camera.

As shown in FIG. 4, a virtual object 55, a virtual left camera 50L, and a virtual right camera 50R are arranged in the virtual space. Here, a position of the virtual left camera 50L is indicated by a point OL, and a position of the virtual right camera 50R is indicated by a point OR. An imaging direction 60L of the virtual left camera 50L and an imaging direction 60R of the virtual right camera 50R are the same, and both the cameras are arranged in a direction perpendicular to these imaging directions so as to have a predetermined interval therebetween. A distance between the cameras (that is, a distance between the point OL and the point OR) is referred to as distance D between the cameras. Images of the virtual object 55, which is an imaging (rendering) target, are taken (rendered) by using the virtual left camera 50L and the virtual right camera 50R (hereinafter, these may be collectively referred to as virtual cameras).

Next, the rendering ranges the images of which are taken (rendered) by the virtual cameras will be described. As shown in FIG. 4, the virtual left camera SOL and the virtual right camera 50R take (render) images of the virtual space by predetermined view angles to render a virtual space sandwiched between a near clip plane 80N and a far clip plane 80F as a left-eye image (see (a) of FIG. 5) and a right-eye image (see (b) of FIG. 5), respectively. Therefore, the space rendered by the virtual left camera 50L is a region 70L which is in a trapezoidal shape in the overhead view (a trapezoidal shaped region indicated by dotted lines in FIG. 4), and the space rendered by the virtual right camera 50R is a region 70R which is in a trapezoidal shape in the overhead view (a trapezoidal shaped region indicated by solid lines in FIG. 4). The near clip plane 80N refers to a plane which has a depth N from the virtual cameras in the virtual space, and the far clip plane 80F refers to a plane which has a depth F from the virtual cameras. A value of F is larger than a value of N. Here, the depth refers to a distance from each of the virtual cameras in the imaging direction of the virtual camera, and has a value indicative of a degree of depth of the virtual object positioned at the depth in the virtual space. Any values are set to N and F, according to a region to be rendered of the virtual space.

As shown in FIG. 4, a zero parallax plane 80B refers to a plane which has a depth B from the virtual cameras (a value of B is larger than the value of N, and is smaller than the value of F). A screen surface corresponding to the display surface (the display screen of the upper LCD 22) is set on the zero parallax plane 80B, which is a position were the depth is B, and thereby the virtual object positioned on the zero parallax plane 80B is displayed on the display surface as an object (a planarly displayed object), exerting no stereoscopic effect (i.e., zero disparity). The screen surface is set within a region 70C (a trapezoidal shaped region indicated by hatched lines in FIG. 4) which is a region where the region 70L and the region 70R overlap one on the other. In a case where the screen surface is what is represented by the region 75 shown in FIG. 4, a region rendered in the region 75 is cropped from the region 70L rendered by the virtual left camera SOL, the cropped region thereafter undergoes a predetermined conversion, and then is displayed as the left-eye image 75L on the display surface, and a region in the region 75 is cropped from the region 70R rendered by the virtual right camera 50R, the cropped region thereafter undergoes a predetermined conversion, and then is displayed as the right-eye image 75R on the display surface (see FIG. 5 also).

Next, a difference (i.e., the disparity) between a display position of the virtual object 55 in the left-eye image 75L and a display position of the virtual object 55 in the right-eye image 75R will be described. FIG. 5 shows images taken (rendered), of the virtual object 55 (see FIG. 4) positioned frontward relative to the zero parallax plane 80B (the depth has a value smaller than B), by the virtual left camera 50L and the virtual right camera 50R. As shown in FIG. 5, the display position of the virtual object 55 in the left-eye image 75L and the display position of the virtual object 55 in the right-eye image 75R are shifted from each other by a predetermined amount in the left-right direction shown in FIG. 5. The amount of shift is the disparity of the virtual object 55. By setting the parallax barrier ON and displaying the left-eye image 75L and the right-eye image 75R displayed on the display surface (the display region of the upper LCD 22) to (be viewed by) the user's left eye and right eye, respectively, the user is allowed to view the virtual object 55 as a stereoscopically visible image having a stereoscopic effect.

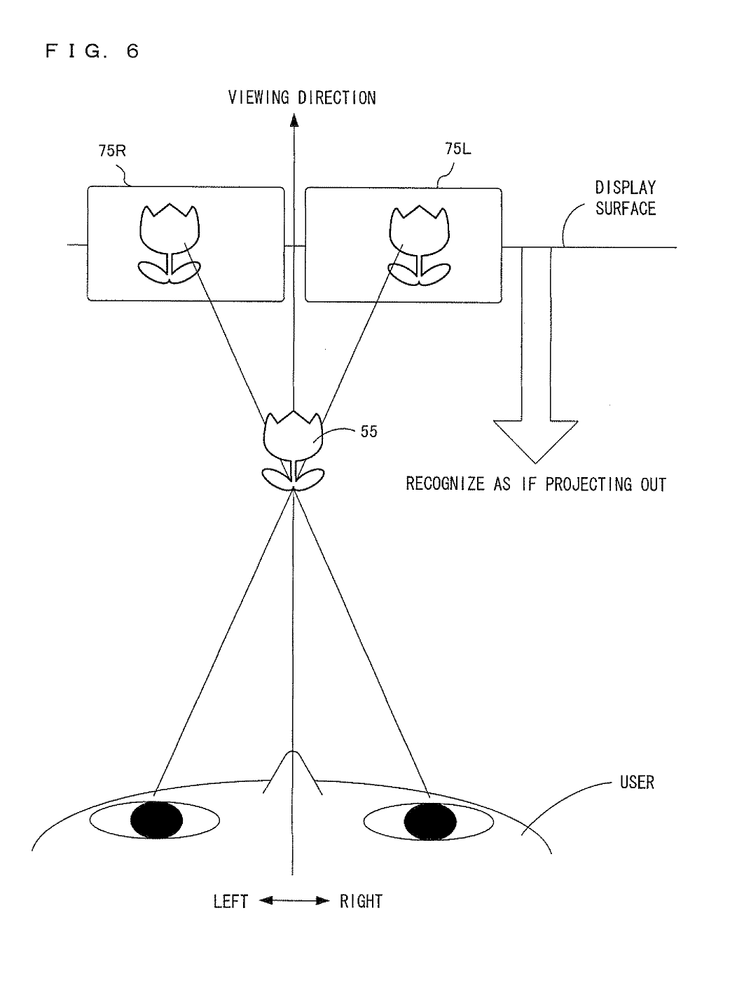

More specifically, as shown in FIG. 5, in the stereoscopically visible image displayed on the display surface (the display region of the upper LCD 22), the display position of the virtual object 55 in the left-eye image 75L is relatively shifted in the right direction relative to the display position of the virtual object 55 in the right-eye image 75R. As shown in FIG. 6, however, when the user views the display surface (the display region of the upper LCD 22) in the viewing direction (the imaging directions of the virtual cameras), only the left-eye image 75L is viewed by the left eye and only the right-eye image 75R is viewed by the right eye, due to the parallax barrier. Therefore, the user views the virtual object 55 in the stereoscopically visible image by a cross view, and thus recognizes as if the virtual object 55 is projecting frontward relative to the predetermined display surface. In a ease where the display position of the virtual object 55 in the left-eye image 75L is relatively shifted in the left direction relative to the display position of the virtual object 55 in the right-eye image 75R, the user views both the images by a parallel view, and thus recognizes as if the virtual object 55 is receding into a distance farther than the predetermined display surface is. In a case where the display positions of the virtual object 55 in the left-eye image 75L and the right-eye image 75R coincide with each other (that is, the disparity is zero), the user recognizes as if the virtual object 55 is positioned on the display surface (not shown). In this manner, allowing the right eye and the left eye (see FIG. 6), which are spaced apart from each other at a predetermined interval in the left-right direction, to view the virtual object 55 in the left-eye image 75L and the right-eye image 75R, respectively, which are also spaced apart from each other by a predetermined amount of shift in the left-right direction, causes the user to recognize the virtual object 55 as an object having the stereoscopic effect.

The virtual object can be stereoscopically viewed as an object having the stereoscopic effect in this manner because the two virtual cameras take (render) images of the virtual object by being spaced apart from each other at a predetermined distance D between the cameras in the direction perpendicular to the imaging direction. The larger the distance D between the cameras becomes, the larger the disparity becomes. Therefore, adjustment of the distance D between the cameras allows adjustment of the stereoscopic effect of the virtual object. In the game apparatus 10 according to the present embodiment, adjustment of the 3D adjustment switch 25 allows the adjustment of the distance D between the cameras. However, a predetermined upper limit value is provided to the distance D between the cameras so that the region 70C where the region 70L rendered by the virtual left camera 50L and the region 70R rendered by the virtual right camera 50R overlap one on the other becomes larger than the region 75 corresponding to the screen surface. When the distance D between the cameras becomes 0 (zero), the images taken by both the cameras are the same and the virtual space is planarly displayed.

As described above, in the game apparatus 10 according to the present embodiment, the virtual space as the stereoscopically visible image (the right-eye image and the left-eye image) is displayed on the display region of the upper LCD 22 and the user is able to view the virtual space having a stereoscopic effect by setting the parallax barrier ON. On the other hand, the stereoscopically visible image described above is not displayed on the display region of the lower LCD 12, but a normal planar visible image is displayed (that is, one image is displayed and thus the same image is viewed by the right and left eyes). Hereinafter, a game executed by the game apparatus 10 according to the present embodiment will be described.

(Outline of Game)

First, an outline of the game executed by the game apparatus 10 in the present embodiment will be described. In the game according to the present embodiment, characteristics of the display region (hereinafter, referred to as upper screen), configured to perform the stereoscopic display, of the upper LCD 22 and characteristics of the display region (hereinafter, referred to as lower screen), configured to perform the planar-view display, of the lower LCD 12 are utilized to perform the stereoscopic display of the game space (the virtual space) on the upper screen and the planar-view display of an object (possession item), which is modeled into a planar shape (planar-modeled), on the lower screen. In the game in the present embodiment, the user can display the planar-modeled possession item, which is displayed on the lower screen, in the stereoscopically displayed game space on the upper screen. In the game in the present embodiment, the possession item displayed on the lower screen is considered as a “seal” having a planar shape, and displaying the seal in the game space displayed on the upper screen is referred to as “applying seal”. When a seal displayed on the lower screen is applied onto the upper screen, the seal is converted into an object in the game space and blends in with the game space on the upper screen. That is, the user can associate a world of seal (a world displayed on the lower screen) with a world of game space (a world displayed on the upper screen) during the game progression.

On the contrary, if the object (the possession item) planarly displayed on the lower screen is displayed on the upper screen on which the stereoscopic display is performed, a sense of discomfort of the appearance may be caused due to the difference between the planar-view display and the stereoscopic display. Thus, in the game apparatus 10 in the present embodiment, a display control, which achieves the reduction in the sense of discomfort of the appearance, is performed. Hereinafter, details of the display control executed on the upper screen and lower screen of the game apparatus 10 at the game progression will be described.

(Display Control in Game Apparatus 10)

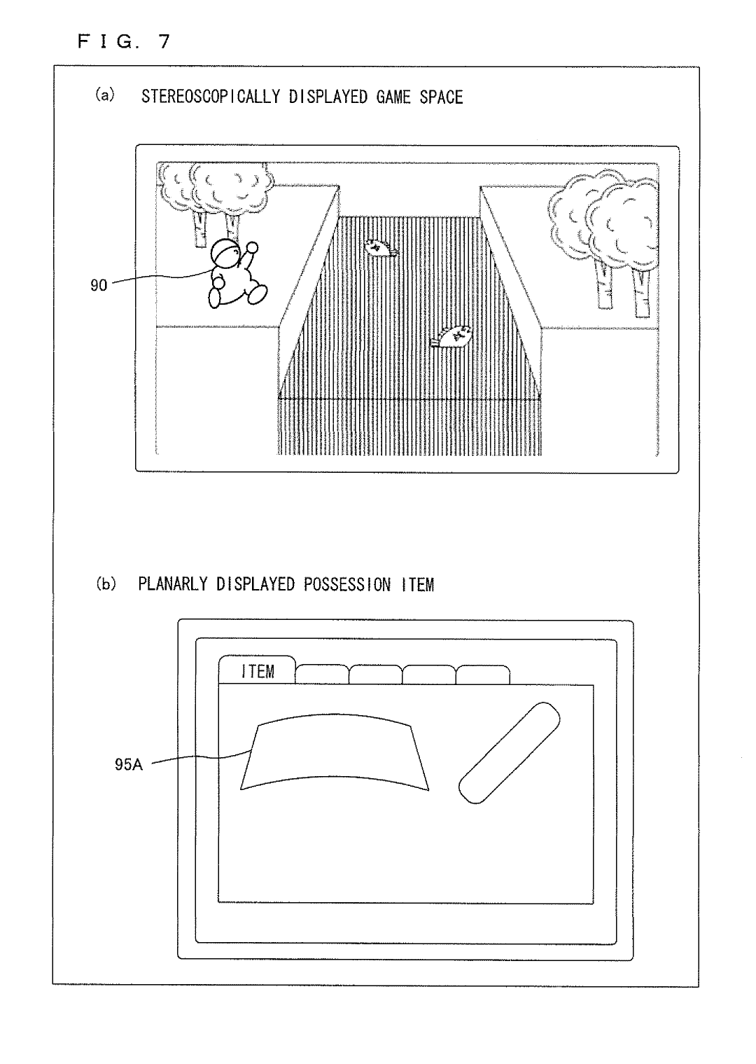

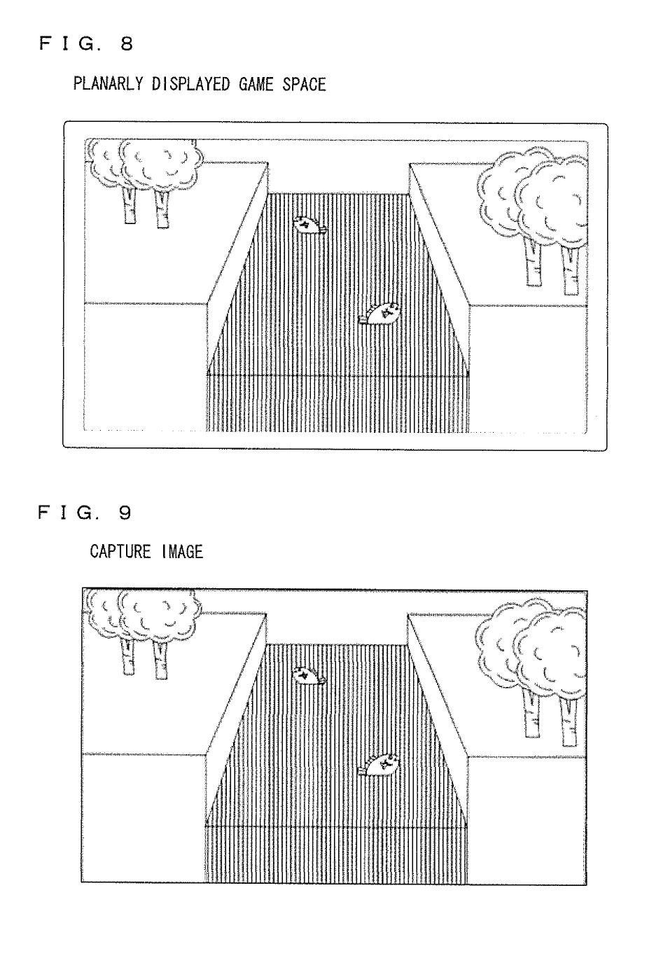

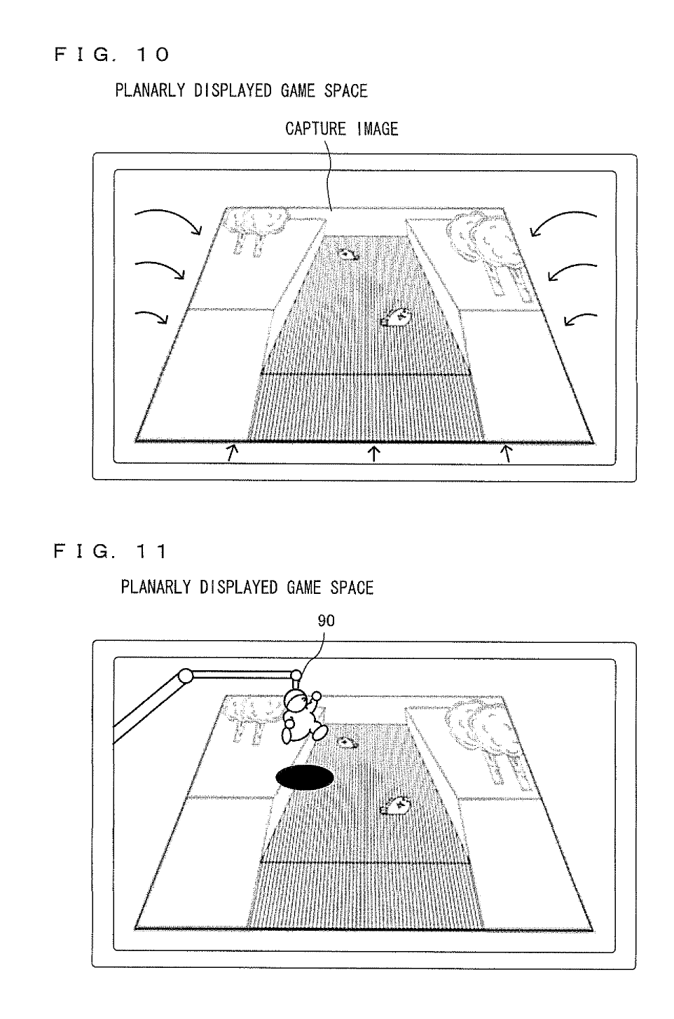

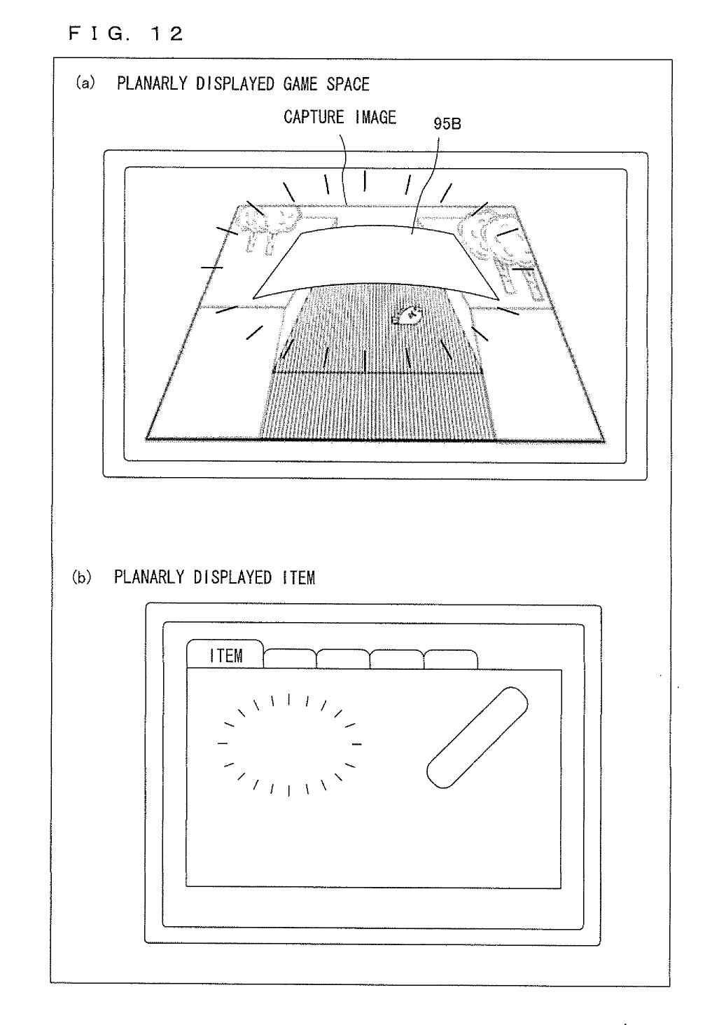

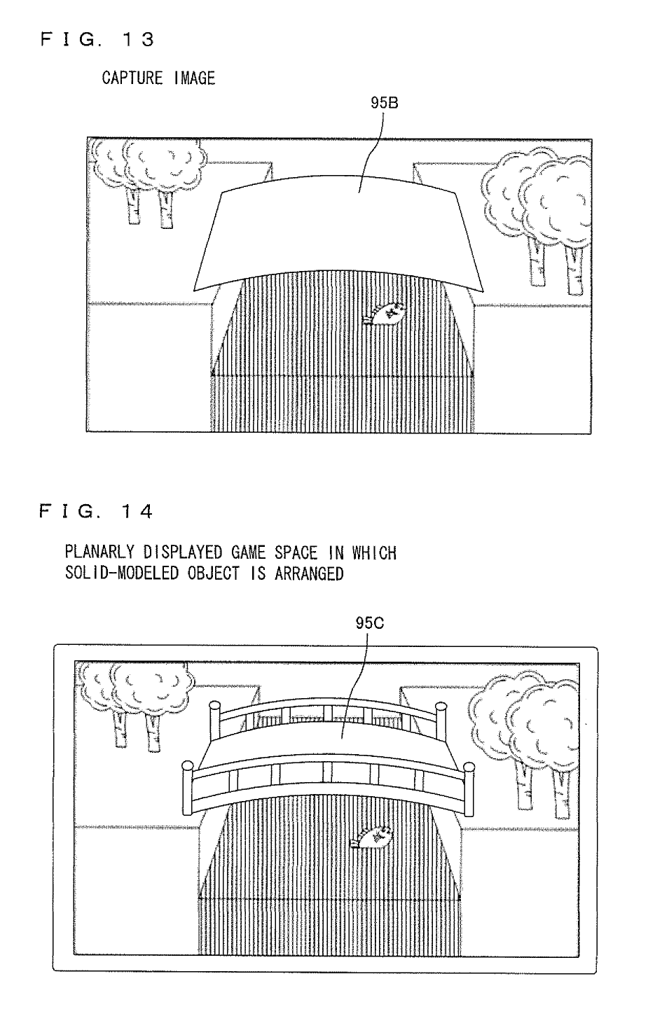

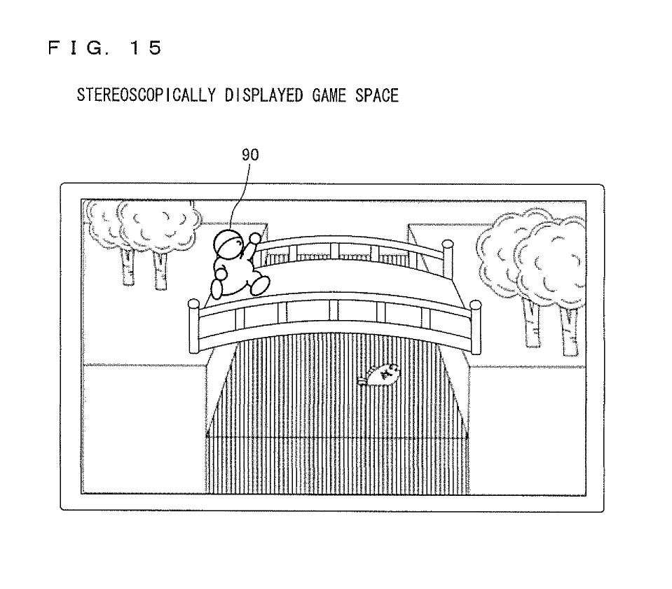

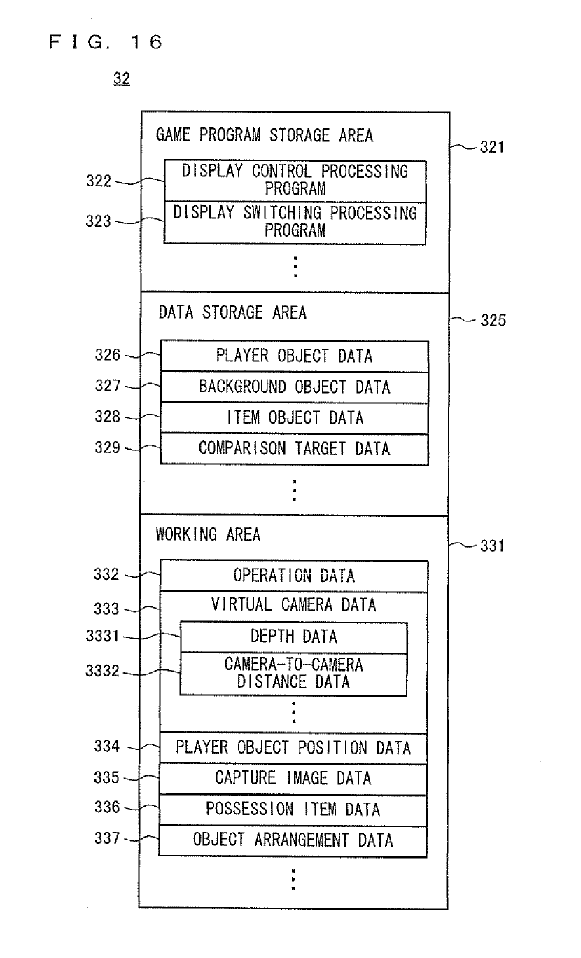

Referring to FIG. 7 to FIG. 15, the display control executed on the upper screen and lower screen of the game apparatus 10 at the game progression will be described. FIG. 7 is a diagram illustrating the game executed by the game apparatus 10 according to the present embodiment. Part (a) of FIG. 7 shows the game space stereoscopically displayed on the upper screen. Part (b) of FIG. 7 shows possession items planarly displayed on the lower screen. FIG. 8 shows the game space switched to the planar-view display on the upper screen. FIG. 9 shows a capture image obtained by capturing the planarly displayed game space of FIG. 8. FIG. 10 shows a state where an animation, in which the capture image falls down, is executed on the upper screen. FIG. 11 shows how the user determines a desired position on the capture image on the upper screen. FIG. 12 shows a state where an item on the lower screen moves to the upper screen. Part (a) of FIG. 12 shows a state of the upper screen, and part (b) of FIG. 12 shows a state of the lower screen. FIG. 13 shows the capture image risen up on the upper screen. FIG. 14 shows the planarly displayed game space in which a solid-modeled object is disposed on the upper screen. FIG. 15 shows a state where planarly displayed game space of FIG. 14 is stereoscopically displayed on the upper screen.

As shown in (a) of FIG. 7, the game progresses by the user moving the player object 90 by operating the player object 90 using the operation buttons 14 and the like in the game space (the virtual space) stereoscopically displayed on the upper screen. At this time, the possession item (seal) the user currently possesses (acquires in accordance with the game progression) is planarly displayed on the lower screen. The possession item (seal) is an object (a planar model object) obtained by planar-modeling of a predetermined object in the game space stereoscopically displayed on the upper screen. For example, an item object 95A shown in (b) of FIG. 7 is a planar model object obtained by planar-modeling of the item object 95C (see FIG. 14 described below) stereoscopically displayed on the upper screen. A figure of the item object 95A is omitted.

During the progression of the game while moving the player object 90 displayed on the upper screen, the user can test the availability (i.e., applicability of the seal) of the possessing item (the possession item displayed on the lower screen) by operating the operation buttons 14 and the like. For example, in the present embodiment, the user operates the operation buttons 14 and the like when the player object 90 reaches a point in front of a river in the game space (see (a) of FIG. 7). The button operation by the user as a trigger gradually switches from the stereoscopic display of the game space (except for the player object 90) displayed on the upper screen to the planar-view display thereof (display switching is executed). At this time, another image processing for moving the player object 90, displayed in the game space, out of the game space, such as disappearing the player object 90 by fading it out, may be performed. The display switching is performed automatically, regardless of adjustment of the 3D adjustment switch 25 by the user. In addition, at this time, a presentation-purpose image processing is also performed such that fields of views of the virtual cameras, taking images of (rendering) the game space to be displayed on the upper screen, appear to be undulating waves. Specifically, when initial viewing angles of the virtual cameras taking images of the game space are set to be 1.0, the viewing angles change by increasing up to 1.4, decreasing thereafter down to 0.9, and returning to 1.0 at the end. That is, on the upper screen, an animation involving change, in which the virtual cameras, taking images of the game space, are once pulled backward (zoom out) and thereafter move forward (zoom in), and return to the original position at the end, is displayed. The presentation-purpose image processing is used to allow the user to understandably view a sign that the game display on the upper screen is switched by the button operation performed by the user. Thus, the presentation-purpose image processing is not limited to the above, and, for example, presentation-purpose image processing, such as the entirety of the image displayed on the upper screen illuminates, may be performed. In this manner, the user is able to view the sign that the upper screen is switching from the stereoscopic display to the planar-view display, thus able to perceive the switching of the display on the upper screen without difficulty.

Next, the display on the upper screen switches, from the game space (see FIG. 8) planarly displayed by the display switching described above, to a capture image (see FIG. 9) obtained by capturing the planarly displayed game space. Specifically, the display of the planarly displayed game space, shown in FIG. 8, which has been displayed, is turned OFF, and the capture image is instead disposed on a plane (the zero parallax plane 80B shown in FIG. 4) where no disparity occurs in the game space (the virtual space), and displayed. Therefore, substantially there is no change with respect to the appearance of the upper screen. Thus, the user does not feel a sense of discomfort of the appearance caused by the switching.

Next, on the upper screen, an animation, in which the capture image varies in the game space, is executed. Specifically, an animation, in which the capture image moves in a direction parallel to the depth direction in the planarly displayed game space and the capture image falls down in the depth direction from the lower end of the capture image as an axis, is executed (see FIG. 10). An animation, in which, considering the capture image as one planar-shaped object, the capture image deforms at the falling event as if the capture image, bounced by the impulse of the planar-shaped object, is falling down, may further be executed. That is, on the upper screen, an animation emphasizing that the capture image is one substantially planar-shaped image is executed. This allows the user to view that the game space is converted into one planar-shaped capture image and the obtained image is planarly displayed on the upper screen.

Next, on the upper screen, the user selects a desired position on the planar-shaped capture image which has fallen down in the planarly displayed game space. Specifically, after the animation in which the capture image falls down is executed, the player object 90 is first displayed on the upper screen. In the present embodiment, the player object 90 is hanged by a crane and is movable by the user operation (see FIG. 11). The user moves the player object 90 by operating the analog stick 15 and the like, and determines a desired position by pressing a determination button (e.g., the button 14B). At this time, the user determines the desired position, based on, for example, shadow cast by the player object 90 on the capture image. If the determined position is correct, the next presentation of the game (game display) is executed. For example, it is assumed, in the present embodiment, that a position indicating a boundary between the river and a land on the capture image (a position of the shadow east by the player object 90 shown in FIG. 11) is the correct position. At this time, a position to be selected by the user on the capture image is a position on which the possession item (seal) planarly displayed on the lower screen is applied. Here, since the capture image is emphasized as one planar-shaped image (a planar visible image), the user can obtain a perception of applying a seal on one planar-shaped image. This allows the user to apply the planarly displayed seal onto, not the stereoscopically displayed game space, but the planarly displayed game space, without feeling a sense of discomfort caused by the difference in display.

If the position determined by the user on the capture image is correct, a possession item suitable for (i.e., corresponding to) the determined position, among items possessed by the user, disappears from the lower screen and is displayed on the capture image at a proper position on the upper screen. For example, in the present embodiment, the user possesses the planarly-modeled item object 95A (a bridge seal) as the item suitable for (corresponding to) the position (the position indicating the boundary between the river and the land) determined by the user on the capture image. That is, the item object 95A is displayed on the lower screen (see (b) of FIG. 7). Therefore, the item object 95A (the bridge seal) disappears from the lower screen (see (b) of FIG. 12), and the item object 95B (the bridge seal) is displayed on the upper screen so as to be provided across the river displayed in the capture image (see (a) of FIG. 12). The item object 95B (the bridge seal) displayed (applied) on the capture image has a substantially similar shape as the item object 95A displayed on the lower screen. That is, the user can display the proper item, among possession items displayed on the lower screen, on the capture image on the upper screen by selecting the desired position on the planar-shaped capture image. This allows the user to perceive that the user has applied the seal in the planarly displayed world of seal (the world displayed on the lower screen) onto the planarly displayed world of game space (the world displayed on the upper screen).

Next, an animation, in which the capture image having the item object 95B (the bridge seal) applied thereon (see (a) of FIG. 12) rises up in the game space (the virtual space), is executed. Specifically, an animation opposite to the animation in which the capture image falls down in the game space is executed and the capture image in the standing state is disposed on the plane where no disparity occurs in the game space (see FIG. 13). Therefore, the capture image shown in FIG. 13 is an image of the capture image shown in FIG. 9 having the item object 95B applied thereon.

Next, the upper screen switches from the display of the capture image shown in FIG. 13 to the following display. That is, the upper screen switches to the planar-view display of the game space in which the item object 95C (the bridge in the game space), which is the solid model object (the solid model object which is viewed in a planar manner) obtained by modeling (solid modeling) of the item object 95B (the bridge seal) into a solid shape, is placed in the planarly displayed game space shown in FIG. 8 (see FIG. 14). The switching is preferably performed gradually in a cross-fade manner. This switches the capture image (see FIG. 13) representing (displaying) a characteristic of application of the seal, to the planarly displayed game space. Solid modeling of the applied seal (the item object 95B) (the item object 95B is switched to the item object 95C) is also performed at the same time when the capture image is switched to the planarly displayed game space, and thus the seal is displayed as if gradually melting into (blends in with) the game space. Therefore, the user can apply the planarly displayed seal in the world of seal (the world displayed on the lower screen) onto the planar-shaped image (the capture image) of the world of planarly displayed game space (the world displayed on the upper screen), without feeling the sense of discomfort, and thereafter the user can view how the image (the capture image) having the seal applied thereon gradually switches to the display of the game space without feeling the sense of discomfort.

Last, the planar-view display of the game space shown FIG. 14 gradually switches to the stereoscopic display thereof. Therefore, a game space in which a bridge is newly provided in the game space shown in FIG. 7 is to be stereoscopically displayed. Therefore, the user can stereoscopically display (display, as the item object 95C) the item object 95B, which is the planar model object which has been displayed on the lower screen, on the upper screen on which the stereoscopic display is performed, without feeling a sense of discomfort of the appearance. Then, the user can cause the player object 90 to, for example, walk across the bridge by operating the player object 90 in the new game space (see FIG. 15). While, in the present embodiment, the player object 90 reappears at a timing when the game space switches (returns) to the stereoscopic display, which, however, is merely an illustrative example, and thus not limited to the timing.

As described above, in the game executed in the game apparatus 10 of the present embodiment, the user can display the planar model object, planarly displayed on the lower screen, on the upper screen on which the stereoscopic display is performed. At this time, the virtual space stereoscopically displayed on the upper screen first switches to the planar-view display. This allows reduction in sense of discomfort of the appearance when placing the planar model object, which is planarly displayed, in the stereoscopically displayed virtual space. In addition, the planarly displayed virtual space is displayed as the capture image (one planar-shaped image). This allows the planar model object, which is planarly displayed, to be placed on the capture image, which is also a planar-shaped image, and reduces the sense of discomfort of the appearance when placing the planar model object in the stereoscopically displayed virtual space. Furthermore, the planarly displayed planar model object is placed and then the virtual space switches from the planar-view display to the stereoscopic display. This allows the stereoscopic display of the virtual space in which the planarly displayed planar model object is placed, while reducing the sense of discomfort when placing the planarly displayed object in the stereoscopically displayed virtual space.

(Details of Display Control Process and Display Switching Process)

Next, a display control process and a display switching process which are executed by the information processing section 31 of the game apparatus 10 when the aforementioned game is executed will be described. First, data which are stored in the main memory 32 at the display control process and the display switching process will be described.

(Memory Map)

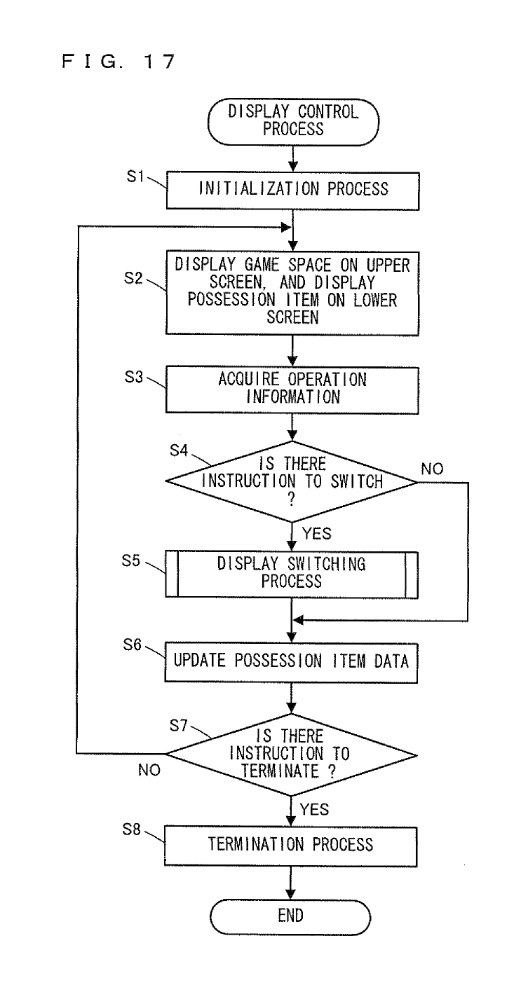

FIG. 16 is a diagram showing, by way of example, a memory configuration of the main memory 32 of the game apparatus 10. As shown in FIG. 16, the main memory 32 has a game program storage area 321, a data storage area 325, and a working area 331. Various programs which are executed by the information processing section 31 are stored in the game program storage area 321. Data for rendering various objects in the virtual space are stored in the data storage area 325. Data in the game program storage area 321 and the data storage area 325 are stored in, for example, the external memory 44, and loaded from the external memory 44 into the main memory 32 and stored therein upon the display control process.

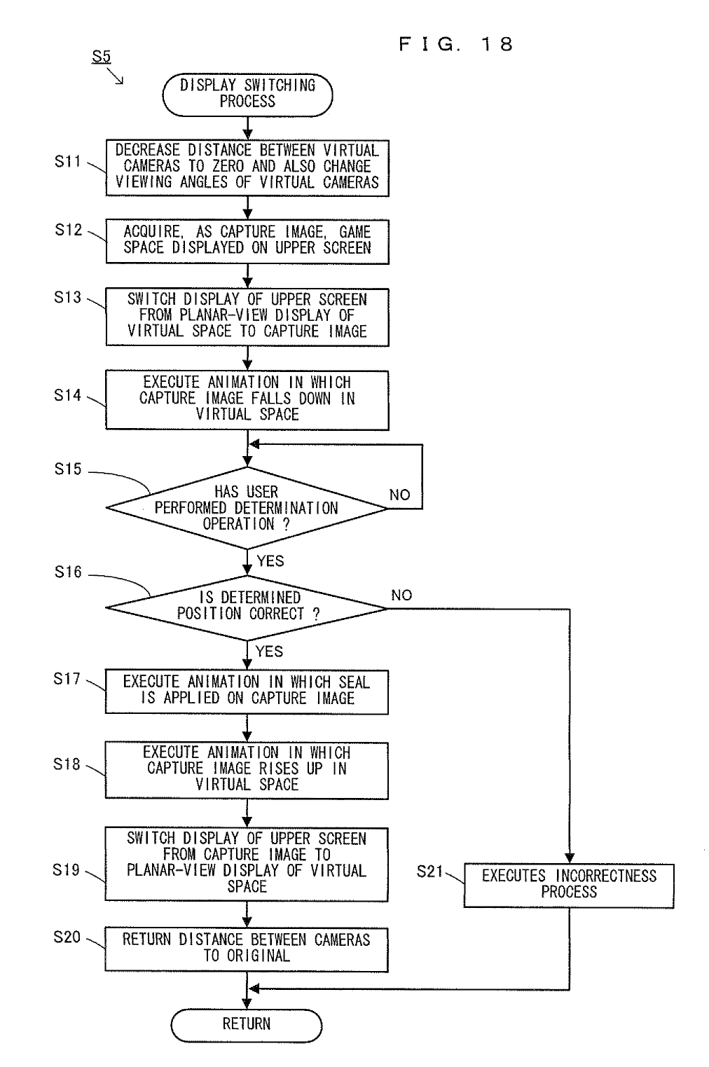

Programs, such as a display control processing program 322 which executes a process of a flowchart shown in FIG. 17 described below or a display switching processing program 323 which executes a process of a flowchart shown in FIG. 18 described below, are stored in the game program storage area 321.

Player object data 326, background object data 327, item object data 328, comparison target data 329, and the like are stored in the data storage area 325.

The player object data 326 is data regarding a player object (the player object 90) in the game space (the virtual space), and includes modeling data, texture data (RGB value), and the like, of the player object. Similarly, the background object data 327 is data regarding background objects (e.g., mountain or river) in the game space. The item object data 328 is data regarding items which can be acquired by the user (e.g., the item object 95A). The item object data 328 also includes data indicative of information which associates the possession item (the item object 95A) displayed on the lower screen with an item (the item objects 95B and 95C) displayed on the upper screen in association with the possession item. The comparison target data 329 is data used in determining whether to display the item on the upper screen, specifically, is data indicative of a position in the virtual space, items which can be displayed at the position, and the like.

The working area 331 is a storage area in which data generated in the display control process and the like are temporarily stored. Operation data 332, virtual camera data 333, player object position data 334, capture image data 335, possession item data 336, object placement data 337, and the like are stored in the working area 331. Portion of the data in the working area 331 are stored in, for example, the external memory 44 or the internal data storage memory 35, and loaded from the external memory 44 or the internal data storage memory 35 and stored into the main memory 32 upon the display control process.

The operation data 332 is data indicative of the user operations performed on operation buttons 14A to 14E and 14G to 14H, the analog stick 15, the 3D adjustment switch 25, and the touch panel 13.

The virtual camera data 333 is data regarding both the virtual cameras (50L, 50R) described with reference to FIG. 4. The virtual camera data 333 is data indicative of the imaging directions (60L and 60R), position coordinates (OL and OR), the viewing angles, of the virtual cameras, and both the images taken by both the virtual cameras. The virtual camera data 333 includes depth data 3331 and camera-to-camera distance data 3332. Here, the depth data 3331 is data indicative of: the depth B which indicates a distance from the positions of the virtual cameras (50L and 50R) in the imaging directions (60L and 60R) of the virtual cameras to a reference plane where no disparity occurs; the depth N which indicates a distance from the positions of the virtual cameras (50L and 50R) in the imaging directions (60L and 60R) of the virtual cameras to the near clip plane; and the depth F which indicates a distance from the positions of the virtual cameras (50L and 50R) in the imaging directions (60L and 60R) of the virtual cameras to the far clip plane (see FIG. 4). The camera-to-camera distance data 3332 is data indicative of the distance D between the cameras (a distance between the point OL and the point OR shown in FIG. 4) which is an interval between the virtual cameras. In the game apparatus 10, the 3D adjustment switch 25 is operated and thereby the camera-to-camera distance data 3332 is updated by the CPU 311 so that the distance D between the cameras indicated by the camera-to-camera distance data 3332 has a value according to the operation of the 3D adjustment switch 25. Also, data indicating both the captured images obtained by both the virtual cameras taking the images is repeatedly updated per frame (e.g., 1/60 second).

The player object position data 334 is data indicative of a position, in the virtual space, of an object (the player object 90) operated by the user in the virtual space.

The capture image data 335 is data indicative of an image (the capture image) obtained by capturing the planarly displayed virtual space.

The possession item data 336 is data indicative of the items which are acquired and possessed by the user during the game progression. On the basis of the possession item data 336, reference is made to the item object data 328, and the possession item is displayed on the lower screen.

The object placement data 337 is data indicative of placement information of the player object, the background objects, the item objects, and the like which are placed in the virtual space. Specifically, the object placement data 337 is data which is updated upon the execution of the display switching process described below.

Portion or the entirety of the main data described above may be stored in the external data storage memory 45, instead of the main memory 32.

(Display Control Process)

The display control process which is executed by the information processing section 31 of the game apparatus 10 will be described. In the game apparatus 10 according to the present embodiment, the game space (the virtual space) is stereoscopically displayed on the upper screen, and the game progresses in accordance with the movement of the player object 90 operated by the user in the game space. At this time, on the lower screen, an item which is acquired by the user in accordance with the game progression is planarly displayed (hereinafter, such display control process is referred to as normal game process). On the other hand, a display control process different from the normal game process is performed at a predetermined timing based on the user operation, such as the stereoscopic display performed on the upper screen turns to the planar-view display, (hereinafter, such display control process is referred to as display switching process). Hereinafter, the display control process including the normal game process and the display switching process will be described.

(Normal Game Process)

Initially, the normal game process described above will be briefly described. FIG. 17 is a flowchart illustrating, by way of example, the display control process which is executed by the GPU 312, based on the CPU 311 or instructions from the CPU 311.

First, in step S1, the CPU 311 of the game apparatus 10 executes an initialization process. Specifically, when the game apparatus 10 is powered on, the CPU 311 executes a boot program stored in the internal data storage memory 35 or the like to initialize each unit, such as the main memory 32. Then, the display control processing program 322 stored in the external memory 44, various data stored in the internal data storage memory 35, and the like are loaded into the main memory 32, and the CPU 311 executes the display control processing program 322. Thereafter, the process proceeds to step S2.

In step S2, the CPU 311 displays the virtual space (the game space) on the upper screen, and displays the possession item on the lower screen (see FIG. 7). Specifically, first, the CPU 311 places the player object 90, the background objects, and the like in the virtual space. That is, the CPU 311 arranges both the virtual cameras (the virtual left camera SOL and the virtual right camera 50R) in the virtual space, based on the virtual camera data 333 loaded into the main memory 32, places the player object 90 in the virtual space, based on the player object position data 334 and the player object data 326, and, additionally, places a background image in the virtual space, based on the background object data 327. The GPU 312 then generates the stereoscopically visible image (the left-eye image and the right-eye image) taken, of the virtual space, by both the virtual cameras, and displays the stereoscopically visible image on the upper screen, based on instructions from the CPU 311. Also, the CPU 311 planarly displays the possession item on the lower screen, based on the item object data 328 corresponding to the possession item data 336 loaded into the main memory 32. Specifically, the GPU 312 displays the possession item (planar visible image) on the lower screen, based on instructions from the CPU 311. Thereafter, the process proceeds to step S3.

In step S3, the CPU 311 receives inputs of operation information from the touch panel 13, the operation buttons 14, the analog stick 15, and the 3D adjustment switch 25. Specifically, operation data indicative of input statuses of the touch panel 13, the operation buttons 14, the analog stick 15, and the 3D adjustment switch 25 are input to the information processing section 31, and therefore the CPU 311 stores the operation data as the operation data 332 in the working area 331. When new operation data 332 is stored therein, old operation data 332 is overwritten by the operation data 332 and thereby the operation data 332 is updated accordingly. Also, the CPU 311 updates the player object position data 334 or the virtual camera data 333 accordingly, based on the operation data 332. Thereafter, the process proceeds to step S4.

In step S4, the CPU 311 determines whether there is operation data, which indicates the display switching process, in the operation data 332 updated in step S3. Specifically, the CPU 311 determines whether there is operation data indicating that the user has pressed any of the operation buttons 14, or the like whereby the display switching of the upper screen is instructed. If the determination result is YES, the process proceeds to the display switching process of step S5. If the determination result is NO, the process proceeds to step S6. Details of the display switching process of step S5 will be described below.

In step S6, the CPU 311 updates the possession item data 336. Although the details will be omitted, the CPU 311 updates the possession item data 336 when it is determined, based on an event or the like performed in accordance with the game progression, that the user has acquired or used a new item. Also, the CPU 311 causes the GPU 312 to perform the planar-view display of the possession item on the lower screen, based on the item object data 328 corresponding to the updated possession item data 336. Thereafter, the process proceeds to step S7.

In step S7, the CPU 311 determines whether there is an instruction from the user to terminate the game. Specifically, the CPU 311 determines whether any of the operation buttons 14 or the like, whereby termination of the game is instructed, has been pressed. If the determination result is YES, the process proceeds to step S8. If the determination result is NO, the process returns to step S2. That is, the process steps of step S2 through S6 are repeated as long as the user does not instruct to terminate the game. The process steps are repeatedly updated per frame (e.g., 1/60 second).

In step S8, the CPU 311 executes a termination process. Specifically, to save a play status up to now, the CPU 311 stores portion of the data stored in the working area 331 (e.g., the possession item data 336) in the internal data storage memory 35 or the like, and ends the display control process. This allows the data stored in the internal data storage memory 35 or the like to be loaded into the main memory 32 at the next game play time, and items possessed at the previous game play time to be again displayed on the lower screen.

(Display Switching Process)

Next, details of the display switching process performed in step S5 described above will be described. FIG. 18 is a flowchart illustrating, by way of example, the display switching process which is executed by the GPU 312, based on the CPU 311 or the instructions from the CPU 311.

In step S11, the CPU 311 executes a process for switching the display of the upper screen. Specifically, the CPU 311 refers to the camera-to-camera distance data 3332 to acquire the current distance D between the cameras, and stores in the working area 331 the distance D between the cameras as data (not shown) indicative of an initial distance D0 between the cameras. The CPU 311 then updates the camera-to-camera distance data 3332 to gradually reduce the distance D between the virtual cameras arranged in the virtual space to zero. Also, at the same time, the CPU 311 updates data indicative of the viewing angles, among the virtual camera data 333, to change the viewing angles of both the virtual cameras. For example, assuming that the initial viewing angles are each 1.0, the CPU 311 changes the viewing angles so as to increase to 1.4, and thereafter decrease to 0.9, and return to 1.0 at the end. On the basis of the instructions from the CPU 311, the GPU 312 then generates the left-eye image and the right-eye image of the virtual space which are taken by both the virtual cameras, per 1 frame (e.g., 1/60 second), which have varying viewing angles and varying distance D between the virtual cameras, and displays both the images on the upper screen. Thereafter, the process proceeds to step S12. At this time, because of the varying viewing angles of both the cameras, the image displayed on the upper screen is viewed as if the presentation-purpose image processing is executed such that the stereoscopically visible image is zoomed out, then in, and returns to the original state at the end. Also, since the distance D between the virtual cameras gradually reduces to zero, the disparity of the stereoscopically visible image displayed on the upper screen gradually reduces, and the stereoscopically visible image is at the end switched to the planar visible image in which the right-eye image and the left-eye image coincide with each other (see FIG. 8).

In step S12, the CPU 311 acquires, as the capture image, the game space (the virtual space) planarly displayed on the upper screen by the process of step S11. Specifically, the CPU 311 acquires, as the capture image, an image of the current virtual space without the player object 90, which is taken by either one of both the virtual cameras, and stores the capture image as the capture image data 335 in the working area 331. Since the positions of both the virtual cameras at this time coincide with each other because of the process of step S11, taking an image by either of the virtual cameras allows acquisition of the same capture image. Also, the CPU 311 stores data regarding the placement of the background objects and the like in the virtual space, as the object placement data 337, in the working area 331. Thereafter, the process proceeds to step S13.

In step S13, the CPU 311 switches the display of the upper screen from the planar-view display of the virtual space to the display of the capture image acquired in step S12. Specifically, the display of the background object and the like placed in the virtual space are set OFF, and, instead, places the capture image on the zero parallax plane in the virtual space for display so as to coincide with the size of the upper screen (see FIG. 9). More specifically, the CPU 311 determines the zero parallax plane in the virtual space, based on the data indicative of the depth B of the depth data 3331, and causes the GPU 312 to display the capture image on the zero parallax plane, based on the capture image data 335. Thereafter, the process proceeds to step S14.

In step S14, the CPU 311 executes an animation in which the capture image placed on the zero parallax plane in the virtual space falls down in the depth direction in the virtual space. Specifically, the CPU 311 shifts the capture image placed on the zero parallax plane in the virtual space in the depth direction by a predetermined amount, and then gradually lays the capture image down in the depth direction by a predetermined angle in the virtual space, considering the capture image as one planar-shaped image. The CPU 311 then causes the GPU 312 to display such the changing state as the planar visible image on the upper screen (see FIG. 10). Thereafter, the process proceeds to step S15.

In step S15, the CPU 311 determines whether the user has performed a determination operation on the capture image for determining the position of the player object 90 (see FIG. 11). Specifically, the CPU 311 refers to the operation data 332 to determine whether the determination button or the like has been pressed. If the determination result is YES, the process proceeds to step S16. If the determination result is NO, the process of step S15 is repeated until the determination operation is performed by the user.

In step S16, the CPU 311 determines whether the position determined by the user is correct. Specifically, after the determination by the CPU 311 in step S15 that the determination operation has been made by the user, the CPU 311 refers to the player object position data 334 to acquire the position designated by the user on the capture image. The CPU 311 then refers to the possession item data 336 to acquire information regarding the items currently possessed by the user. Next, the CPU 311 refers to data which indicates a correct position in the virtual space, among the comparison target data 329, to compare the referred data with the data (the player object position data 334) indicative of the designation position designated by the user. As a result of the comparison, if both the data match, the CPU 311 next determines whether the user possesses any item to be displayed at the correct position. Specifically, the CPU 311 compares the data which indicates an item that can be displayed at the correct position, among the comparison target data 329, with information (the possession item data 336) which indicates the item currently possessed by the user. As the result of the comparison, if both the data match, the CPU 311 determines that the determination operation by the user is correct. If the determination result is YES, the process proceeds to step S17. If the determination result is NO, the process proceeds to step S21.

In step S17, the CPU 311 executes the display control process in which a seal (the possession item planarly displayed on the lower screen) is applied on the capture image on the upper screen. Specifically, among the possession items displayed on the lower screen, the CPU 311 displays the item object, which corresponds to the data indicative of the item determined to be correct by the determination process in step S16, at a predetermined position on the capture image, which has fallen down in the virtual space in step S14, on the upper screen. For example, if the user possesses the item object 95A, data indicative of the item object 95A as the possession item data 336 is stored in the working area 331. In the case where the data indicative of the item, which is determined to be correct and can be displayed, is the data indicative of the item object 95A, the CPU 311 refers to the item object data 328 to acquire the data indicative of the item object 95B (an object to be planarly displayed on the upper screen) associated with the item object 95A, and places the item object 95B at a predetermined position on the capture image (applies the seal). On the basis of instructions from the CPU 311, the GPU 312 then displays the virtual space, in which the capture image having the seal applied thereon is placed, as the planar visible image on the upper screen. Also, at the same time, the CPU 311 sets OFF the display of the item object 95A displayed on the lower screen (see FIG. 12). At this time, to emphasize that the item object 95A on the lower screen is hidden, presentation, such as the lower screen illuminates, may be executed. Thereafter, the process proceeds to step S18.

In step S18, the CPU 311 executes an animation in which the capture image fallen down on the virtual space rises up. Specifically, the CPU 311 executes a process opposite to the process executed in step S14. That is, the CPU 311 restores the capture image by raising up the capture image, which has fallen down in the depth direction (the imaging directions) from the zero parallax plane, in the frontward direction, restoring the predetermined amount shifted by in the depth direction to the frontward side so that the capture image fits to the entire size of the upper screen (see FIG. 13). The CPU 311 then causes the GPU 312 to display such the changing state as the planar visible image on the upper screen. Thereafter, the process proceeds to step S19.

In step S19, the CPU 311 switches the display of the upper screen from the display of the capture image on which the seal (the item object 95B) is applied, to the planar-view display of the virtual space (see FIG. 14). Specifically, first, the CPU 311 refers to the object placement data 337, which is stored in the working area 331 upon the process of step S12, to reconstruct the virtual space at the time when the process of step S12 is performed. The CPU 311 then places the solid-modeled item object 95C at a predetermined position on the virtual space. The predetermined position is a position previously determined so as to correspond to the position of the seal (the item object 95B) applied on the capture image. Next, the CPU 311 causes the GPU 312 to generate a planar visible image, of the virtual space, which is taken by either of both the virtual cameras, and stores the planar visible image as imaging data of the virtual camera data 333 in the working area 331. The CPU 311 then causes the GPU 312 to switch the display of the upper screen in a cross-fade manner, from the currently displayed capture image to the planar visible image, which has been stored as the imaging data of the virtual camera data 333. Specifically, the GPU 312 gradually switches the image displayed on the upper screen from the capture image to the planar visible image, while changing the transparency of the capture image and the planar visible image. Thereafter, the process proceeds to step S20.

In step S20, the CPU 311 performs a process for returning the distance D between the cameras set to be zero in step S11 to the initial distance D0 between the cameras. Specifically, on the basis of the initial distance D0 between the cameras stored in the working area 331, the CPU 311 updates the camera-to-camera distance data 3332, thereby gradually returning the distance D between the virtual cameras arranged in the virtual space from 0 to D0 (that is, the distance between cameras prior to the process of step S11 being performed). This switches the upper screen from the planar-view display to the stereoscopic display (see FIG. 15). Also, at which time, the planar visible image, in which the solid model object (the item object 95C) is placed in the virtual space, is gradually switched to the stereoscopically visible image, which therefore does not give the user a sense of discomfort of the appearance. Thereafter, the process returns to the display control process of FIG. 17, and proceeds to the following step S6.

On the other hand, in step S21, the CPU 311 executes an incorrectness process. Specifically, the CPU 311, as in step S18, executes an animation in which the capture image fallen down on the virtual space rises up. Then, the CPU 311, as in step S19, switches the display of the upper screen from the display of the capture image to the planar-view display of the virtual space. The CPU 311 thereafter, as in step S20, performs a process for returning the distance D between the cameras, which is zero, to the initial distance D0 between the cameras. This returns the upper screen to the stereoscopic display of the virtual space prior to the execution of the process of step S11 (that is, prior to the execution of the display switching process). Thereafter, the process returns to the display control process of FIG. 17, and proceeds to the following step S6.

(Modification)

In the above embodiment, the upper screen switches from the stereoscopic display to the planar-view display, and the virtual space planarly displayed on the upper screen is displayed as the capture image (that is, the display of the upper screen switches from the planar-view display of the virtual space to the display of the capture image) (see steps S11, S12, and S13 shown in FIG. 8, FIG. 9, and FIG. 18). Alternatively, however, the steps for displaying the capture image may not be performed. Specifically, the process of steps S12 to S14 of FIG. 18, and the process of steps S17 and S18 may not be performed. In this case, in step S15, the CPU 311 determines whether a determination operation performed by the user to determine the position of the player object 90 on the planarly displayed virtual space has been performed. Then, in a case where the CPU 311 has determined, in step S16, that the position determined by the user and the item (the item object 95A) possessed by the user are correct, the CPU 311 places the solid-modeled item object 95C at the predetermined position on the virtual space in step S19. Then, the CPU 311 switches the virtual space, in which the item object 95C is placed, from the planar-view display to the stereoscopic display in step S20. Even in this case, when placing the planarly displayed item object in the stereoscopically displayed virtual space, the stereoscopically displayed virtual space has switched to the planar-view display. Therefore, the sense of discomfort of the appearance when placing the planarly displayed item object in the stereoscopically displayed virtual space can be reduced.

Also, in the above embodiment, the seal (the item object 95A planarly displayed on the lower screen) is applied on the capture image on the upper screen after the capture image has fallen down in the virtual space (see step S17 shown in FIG. 12 and FIG. 18). Alternatively, however, the seal may be applied on the capture image on the upper screen after the capture image, fallen down in the virtual space, has risen up. That is, the process of step S17 in FIG. 18 may be executed after the execution of the process of step S18.

Also, in the above embodiment, the conditions for applying the seal (the item object 95A planarly displayed on the lower screen), which is displayed on the lower screen, onto the upper screen are that: a position determined by the user on the capture image is a correct position (correct); and the user possesses the item to be displayed on the position (see step S16 of FIG. 18). The conditions for the application of the seal are not limited thereto, and can be changed accordingly, depending on the content of the game. For example, a condition, such as the seal cannot be applied if the background object placed in the virtual space is an object representing a night background, may be further added.

Also, in the above embodiment, the timing, at which the display switching process is performed, is when any of the operation buttons 14 and the like whereby the display switching process is instructed from the user has been pressed (see step S4 of FIG. 17). That is, the display switching process is executable at any time by the user's instruction. Alternatively, however, predetermined conditions in accordance with the number of points held by the player object 90 and the like may be added to allow the execution of the display switching process. For example, in a case where the player object 90 does not hold the predetermined number of points, the display switching process may not be performed. Alternatively, the display switching process may be executed under a condition that the player object 90 is positioned in a predetermined area.

Also, in the above embodiment, the determination whether the seal can be applied is executed in the display switching process (see step S16 of FIG. 18). Alternatively, however, the determination whether the seal can be applied may be executed prior to the execution of the display switching process. Specifically, the user performs the determination operation by operating the player object 90 and pressing any of the operation buttons 14 and the like at a desired position in the game space (the upper screen on which the stereoscopic display is performed). At this time, in step S4 of FIG. 17, the CPU 311 performs the determination process executed in step S16 of FIG. 18, based on the display position of the player object 90 in the virtual space. Then, if the result of the determination process is affirmative (YES), the display switching process is executed. In this case, the process of step S15 and step S16 shown in FIG. 18 is not performed. According to the modification, in the case where the seal can in fact not be applied, the display switching process is not executed. Therefore, the user is able to determine whether the seal can be applied by viewing that the display switching is not executed on the upper screen.

Also, in the above embodiment, in the case where a position determined by the user on the capture image is correct, it is determined whether the user possesses an item to be displayed at the position, and, if the user possesses the item, the item is automatically applied onto the upper screen (see step S16 of FIG. 18). Alternatively, however, the user may be able to select by herself/himself a seal to be applied onto the upper screen from item objects displayed on the lower screen. Specifically, in step S16, the user determines a position to apply the seal on the capture image, and then selects by herself/himself a seal to be applied from the possession items. In this case, the CPU 311 compares the position selected on the capture image and the item selected by the user with the comparison target data 329, and the selected seal is applied onto (displayed) the upper screen only if both the data matches with the comparison target data 329. Alternatively, the process of step S15 and S16 may not be performed, and the seal selected by the user may be automatically applied onto the upper screen at a predetermined position on the capture image if the item selected by the user can be applied on the capture image (that is, if the position onto which the selected seal to be applied is within the capture image).

Also, in the above embodiment, when the seal (the possession item) displayed on the lower screen is applied onto the upper screen, the display of the seal on the lower screen is set OFF, and the seal is displayed (appears) on the upper screen instead (see step S17 shown in FIG. 12 and FIG. 18). Alternatively, however, when the seal displayed on the lower screen is applied onto the upper screen, a display control may be performed such that the seal on the lower screen gradually moves upward on the lower screen and the seal gradually appears on the upper screen from below thereof in correspondence with the movement. In this case, the user is allowed to perceive an image as if the seal on the lower screen is moving to the upper screen, which provides the user with a sensation of connection between the world of seal (the world displayed on the lower screen) and the world of game space (the world displayed on the upper screen).

Also, in the above embodiment, the planar model object changes to the solid model object (the item object 95C) at the timing when the display of the capture image having the planar model object (the item object 95B) applied thereon switches to the planar-view display of the game space on the upper screen (see FIG. 14). However, the timing when the planar model object changes to the solid model object is not limited thereto. For example, an object may change to a solid model object at the time when the object is applied onto the capture image. That is, the solid model object (the item object 95C) may be applied on the capture image shown in FIG. 13. Furthermore, the possession item (the item object 95A) displayed on the lower screen may be the solid model object (the item object 95C) from the start.

Also, in the above embodiment, in the case where the position selected and determined by the user on the capture image is incorrect, the incorrectness process of step S21 shown in FIG. 18 is executed. However, the incorrectness process is not limited to the above embodiment, and can be changed accordingly, depending on the content of the game. For example, in the case of incorrectness, the animation in which the capture image rises up may not be executed on the upper screen, and the upper screen may instantly switch to the stereoscopic display prior to the execution of the display switching process. Furthermore, at this time, an animation emphasizing incorrectness (e.g., animated explosion) may be executed and the upper screen may then be switched to the original stereoscopic display.

Also, in the above embodiment, the switching from the stereoscopic display to the planar-view display on the upper screen is performed by adjusting the distance D between the virtual cameras (see step S11 of FIG. 18 and the like). Alternatively, however, when switching the stereoscopic display to the planar-view display on the upper screen, the stereoscopically visible image (the right-eye image and the left-eye image) displayed on the upper screen may be switched to a single planar visible image for display and thereby the single image may be displayed to both the user's right and left eyes. For example, the single image may be the left-eye image taken, of the virtual space, by the virtual left camera 50L. A virtual middle camera may be arranged at the middle between the virtual left camera 50L and the virtual right camera 50R and the single image may be an image taken, of the virtual space, by the virtual middle camera.

Also, in the above embodiment, the upper screen returns from the planar-view display to the stereoscopic display soon after a planarly displayed object (seal) is placed (applied) on the upper screen (see step S20 of FIG. 18). However, the timing at which the upper screen returns (switches) from the planar-view display to the stereoscopic display is not limited thereto. For example, the upper screen may return from the planar-view display to the stereoscopic display when a planarly displayed object is placed on the upper screen and the object disappears from the upper screen (that is, such as when the object moves outside the imaging range of the virtual space along with the game progression).

Also, in the above embodiment, the description is given that the stereoscopically visible image displayed on the upper LCD 22 (the upper screen) is stereoscopically viewable with the naked eye. For example, an image which can be stereoscopically viewed by the user wearing glasses for viewing stereoscopic images may be displayed (i.e., an image in which the left-eye image and the right-eye image are alternately displayed by a time division scheme).

Also, in the above embodiment, the imaging direction 60L of the virtual left camera 50L and the imaging direction 60R of the virtual right camera 50R are parallel to each other and images of the virtual space are taken by the parallel method. However, the present example embodiment is not limited thereto, and, for example, the imaging directions of both the virtual cameras may not be parallel but may cross with each other and images of the virtual space may be taken by the cross-eye method.

Also, while, in the above embodiment, the example embodiment is applied to the game apparatus 10, the example embodiment is not limited to the game apparatus 10. For example, the example embodiment can also be applied to portable information terminal apparatuses such as mobile phones, personal handy-phones (PHS), PDAs, and the like. The example embodiment is also applicable to stationary game apparatuses, personal computers, or the like.

Also, while, in the above embodiment, the above described processes are executed by one game apparatus 10, the processes may be divided and performed by a plurality of apparatuses communicatively connected by wire or wirelessly to each other.

In addition, in the above embodiment, the shape of the game apparatus 10, the shapes, numbers, installation positions of the various operation buttons 14, the touch panel 13, and the like which are provided on the game apparatus 10 are merely illustrative example, and it is understood that other shapes, numbers and installation positions may be used to realize the example embodiment. The processing orders used for the above-described information processing, setting values, values used for determination, and the like are merely illustrative example. It is to be understood that other processing orders and values may be used without departing from the scope of the appended claims to realize the example embodiment.

The various information processing programs executed in the game apparatus 10 of the present embodiment described above may be provided to the game apparatus 10 through not only a storage medium such as the external memory 44 but also through a wired or wireless communication line. Alternatively, the programs may be prestored in a nonvolatile storage apparatus (such as the internal data storage memory 35) provided in the game apparatus 10. An information storage medium for storing the programs may be an nonvolatile memory as well as a CD-ROM, a DVD, and a like optical disc-shaped storage media, a flexible disc, a hard disc, a magneto-optical disc, a magnetic tape, and the like. Further, an information storage medium for storing the programs may be a volatile memory which temporarily stores the programs.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A computer-readable storage medium having stored therein a display control program to be executed by a computer of a display control apparatus configured to perform a stereoscopic display and a planar-view display on a display unit, the display control program causing the computer to function as:
stereoscopic display control means for performing a stereoscopic display of a virtual space on the display unit;
display switching means for switching the stereoscopic display of the virtual space on the display unit performed by the stereoscopic display control means to a planar-view display thereof, in accordance with predetermined switching conditions; and
planar visible object display control means for displaying a planar visible object on the display unit after the stereoscopic display is switched by the display switching means to the planar-view display.

2. The computer-readable storage medium having stored therein the display control program according to claim 1, wherein the display switching means switches from the planar-view display to the stereoscopic display after the planar visible object is displayed by the planar visible object display control means.

3. The computer-readable storage medium having stored therein the display control program according to claim 2, wherein
the display control program causes the computer to further function as object conversion means for converting the planar visible object into a solid model object representing a solid model of the planar visible object,
the planar visible object display control means displays a planar model object representing a planar model of the planar visible object, as the planar visible object, on the display unit,
the object conversion means converts the planar model object into the solid model object and places the solid model object in the virtual space, and
the display switching means switches from the planar-view display of the virtual space, in which the solid model object into which the planar model object is converted by the object conversion means is placed, to the stereoscopic display thereof.

4. The computer-readable storage medium having stored therein the display control program according to claim 1, wherein
the display unit comprises: a first display section configured to perform a planar-view display and a stereoscopic display; and a second display section configured to perform a planar-view display, and
the planar visible object is an object planarly displayed on the second display section.

5. The computer-readable storage medium having stored therein the display control program according to claim 4, wherein
the stereoscopic display control means performs the stereoscopic display of the virtual space on the first display section,
the display switching means switches the stereoscopic display of the virtual space on the first display section performed by the stereoscopic display control means to the planar-view display thereof, in accordance with the predetermined switching conditions, and
after the stereoscopic display of the virtual space on the first display section is switched by the display switching means to the planar-view display thereof, the planar visible object display control means deletes the planar visible object planarly displayed on the second display section from the second display section, and displays the planar visible object on the first display section.

6. The computer-readable storage medium having stored therein the display control program according to claim 1, wherein
the display control program causes the computer to further function as capture image output control means for acquiring, as a capture image, a planar visible image of the planar-view display of the virtual space switched by the display switching means, and outputting the capture image to the display unit, and
the planar visible object display control means displays the planar visible object on the capture image outputted to the display unit.

7. The computer-readable storage medium having stored therein the display control program according to claim 6, wherein the capture image output control means outputs the capture image on a reference plane where no disparity occurs in the virtual space displayed on the display unit.

8. The computer-readable storage medium having stored therein the display control program according to claim 6, wherein the display control program causes the computer to further function as capture image change means for changing the capture image outputted by the capture image output control means so as to tilt in a depth direction in the virtual space.

9. The computer-readable storage medium having stored therein the display control program according to claim 1, wherein
the display control program causes the computer to further function as virtual camera setting means for arranging two virtual cameras, which take images of the virtual space, so as to have a predetermined interval therebetween,
the stereoscopic display control means performs the stereoscopically display of the virtual space on the display unit by outputting a stereoscopically visible image made up of a right-eye image and a left-eye image taken, of the virtual space, by the two virtual cameras arranged by the virtual camera setting means so as to have the predetermined interval therebetween, and
by causing the virtual camera setting means to set 0 to the predetermined interval between the two virtual cameras, the display switching means switches the stereoscopic display of the virtual space performed by the stereoscopic display control means to the planar-view display thereof.

10. The computer-readable storage medium having stored therein the display control program according to claim 9, wherein the display switching means switches the stereoscopic display of the virtual space performed by the stereoscopic display control means to the planar-view display thereof by causing the virtual camera setting means to set the predetermined interval between the two virtual cameras to be gradually reduced.

11. The computer-readable storage medium having stored therein the display control program according to claim 1, wherein
the display control program causes the computer to further function as display conditions determination means for determining whether display conditions for displaying the planar visible object on the display unit are satisfied, and
the predetermined switching conditions are that the display conditions determination means determines that the display conditions are satisfied.

12. The computer-readable storage medium having stored therein the display control program according to claim 11, wherein
the display control program causes the computer to further function as:
input reception means for receiving an input from a user; and
position locating means for locating a position in the virtual space, based on the input received by the input reception means, and
the display conditions determination means makes determination, based on conditions, as the display conditions, that the position located by the position locating means is the predetermined position.

13. The computer-readable storage medium having stored therein the display control program according to claim 5, wherein
the display control program further causes the computer to function as:
input reception means for receiving an input from a user; and
planar visible object identification means for identifying, based on the input received by the input reception means, a planar visible object to be displayed on the first display section, among planar visible objects planarly displayed on the second display section, and
the planar visible object display control means displays on the first display section the planar visible object identified by the planar visible object identification means.

14. The computer-readable storage medium having stored therein the display control program according to claim 1, wherein
the display control program causes the computer to further function as virtual camera setting means for arranging two virtual cameras, which take images of the virtual space, so as to have a predetermined interval therebetween,
the stereoscopic display control means performs the stereoscopic display of the virtual space on the display unit by outputting a stereoscopically visible image made up of a right-eye image and a left-eye image taken, of the virtual space, by the two virtual cameras arranged by the virtual camera setting means so as to have the predetermined interval therebetween, and
by replacing the stereoscopically visible image with a single planar visible image rendering the virtual space, the display switching means switches the stereoscopic display of the virtual space performed by the stereoscopic display control means to the planar-view display thereof.

15. A display control apparatus configured to perform a stereoscopic display and a planar-view display on a display unit; the display control apparatus comprising:
stereoscopic display control means for performing a stereoscopic display of a virtual space on the display unit;
display switching means for switching the stereoscopic display of the virtual space on the display unit performed by the stereoscopic display control means to a planar-view display thereof, in accordance with predetermined switching conditions; and
planar visible object display control means for displaying a planar visible object on the display unit after the stereoscopic display is switched by the display switching means to the planar-view display.

16. A display control system configured to perform a stereoscopic display and a planar-view display on a display unit, the display control system comprising:
stereoscopic display control means for performing a stereoscopic display of a virtual space on the display unit;
display switching means for switching the stereoscopic display of the virtual space on the display unit performed by the stereoscopic display control means to a planar-view display thereof, in accordance with predetermined switching conditions,
object display control means for displaying a planar visible object on the display unit after the stereoscopic display is switched by the display switching means to the planar-view display.

17. A display control method in a display control apparatus configured to perform a stereoscopic display and a planar-view display on a display unit, the display control method comprising:
a stereoscopic display control step of performing a stereoscopic display of a virtual space on the display unit;
a display switching step of switching the stereoscopic display of the virtual space performed in the stereoscopic display control step to a planar-view display thereof, in accordance with predetermined conditions; and
an object display control step for displaying a planar visible object on the display unit after the stereoscopic display is switched in the display switching step to the planar-view display.
